(19) United States
(12) Patent Application Publication
(10) Pub. No.: US 2025/0240826 A1
(43) Pub. Date: Jul. 24, 2025

(54) METHOD AND APPARATUS FOR RANDOM ACCESS IN A WIRELESS COMMUNICATION SYSTEM

(71) Applicant: ASUS Technology Licensing Inc., Taipei City (TW)

(72) Inventor: Ko-Chiang Lin, Taipei City (TW)

(21) Appl. No.: 19/028,472

(22) Filed: Jan. 17, 2025

Related U.S. Application Data
(60) Provisional application No. 63/622,705, filed on Jan. 19, 2024.
(60) Provisional application No. 63/622,720, filed on Jan. 19, 2024.

(51) Int. Cl. H04W 74/0833; H04W 48/06

(52) U.S. Cl. CPC H04W 74/0833; H04W 48/06

(57) ABSTRACT

A method and device for a User Equipment (UE) are disclosed. In one embodiment, the UE determines whether to initiate a random access procedure on a cell to request SIB1 from a base station based on information related to access barring.

### CROSS-REFERENCE TO RELATED APPLICATIONS

The present Application claims the benefit of U.S. Provisional Patent Application Ser. Nos. 63/622,705 and 63/622,720 filed on Jan. 19, 2024, the entire disclosures of which are incorporated herein in their entirety by reference.

### FIELD

This disclosure generally relates to wireless communication networks, and more particularly, to a method and apparatus for random access in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a User Equipment (UE) are disclosed. In one embodiment, the UE determines whether to initiate a random access procedure on a cell to request SIB1 from a base station based on information related to access barring.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.3.3.1-1 of 3GPP TS 38.331 V17.6.0.

FIG. 6 is a reproduction of FIG. 5.3.3.1-2 of 3GPP TS 38.331 V17.6.0.

FIG. 7 is a reproduction of FIG. 5.3.13.1-1 of 3GPP TS 38.331 V17.6.0.

FIG. 8 is a reproduction of FIG. 5.3.13.1-2 of 3GPP TS 38.331 V17.6.0.

FIG. 9 is a reproduction of FIG. 5.3.13.1-3 of 3GPP TS 38.331 V17.6.0.

FIG. 10 is a reproduction of FIG. 5.3.13.1-4 of 3GPP TS 38.331 V17.6.0.

FIG. 11 is a reproduction of FIG. 5.3.13.1-5 of 3GPP TS 38.331 V17.6.0.

FIG. 12 is a flow chart according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.211 V15.7.0, “NR; Physical channels and modulation (Release 15)”; TS 38.213 V18.0.0, “NR; Physical layer procedures for control (Release 18)”; TS 38.321 V17.6.0, “NR; Medium Access (MAC) protocol specification (Release 17)”; TS 38.331 V17.6.0, “NR; Radio Resource Control (RRC) protocol specification (Release 17)”; and RP-234065, “New WID: Enhancements of network energy savings for NR”, Ericsson. The standards and documents listed above are hereby expressly incorporated by reference in their entirety.

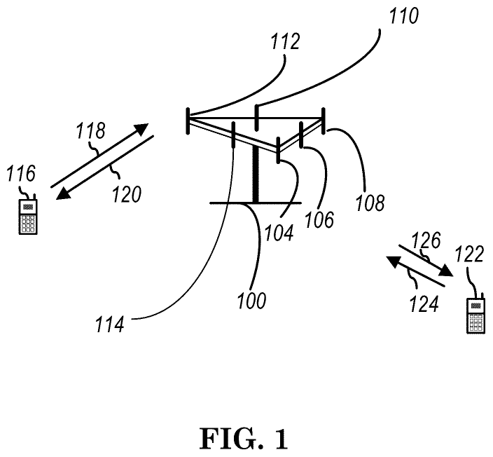

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

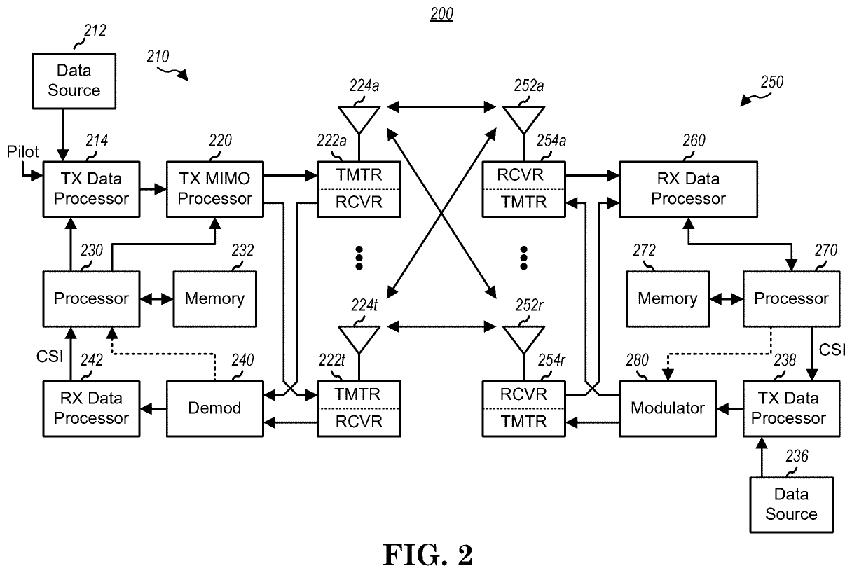

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

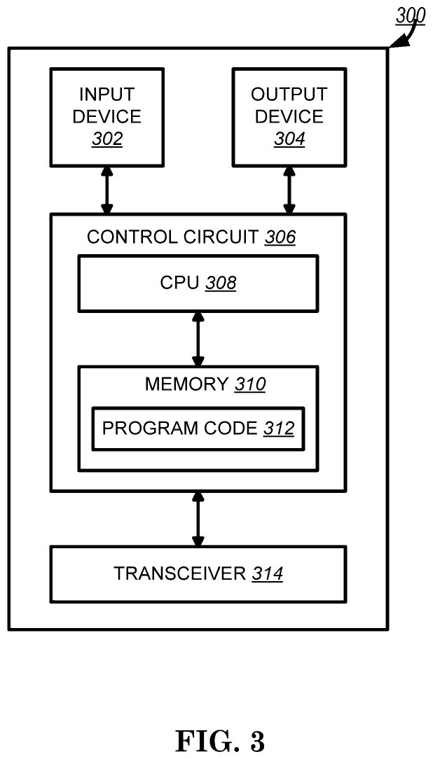

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

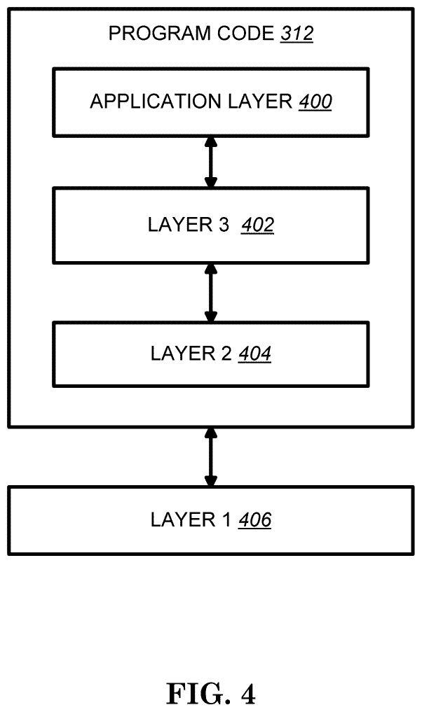

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Random access procedure is introduced for several purposes, e.g. to acquire UL synchronization (e.g. UL TA), to ask for UL grants resource(s), to recover form beam failure and so on. Random access procedure could be categorized into contention based random access procedure and non-contention based random access procedure. For non-contention based random access procedure, a dedicated preamble (as well as dedicated PRACH resource) is assigned to the UE so that gNB could identify the UE transmitting the preamble via preamble detection/reception. For requesting system information, a dedicated preamble could be allocated for requesting a (specific) SI/SIB(s) (e.g. SIB2). The dedicated preamble could be utilized by all UEs requesting the SI/SIB(s). (e.g. for requesting system information, identifying the UE is not necessary) The UE would then monitor random access response from the base station. The non-contention based random access procedure would be considered as complete successfully when/if the random access response to the transmitted preamble is received. On the other hand, for contention-based random access procedure, a preamble is randomly selected from a set of available preambles (e.g. which may depends on a purpose or situation or UE which initiates the random access procedure). After transmitting the random access preamble, the UE could monitor the corresponding random access response. After successfully receiving the random access response, the UE would transmit a Msg 3 (which could be used to identified the UE). After transmitting Msg3, the UE would monitor a contention resolution (e.g. Msg 4). If contention resolution for the UE is successfully received, the UE would consider the random access procedure is successfully finished.

More details related to random access procedure are discussed and provided below in 3GPP TS 38.213, TS 38.321, and TS 38.331. In particular, 3GPP TS 38.213 states:

### 8 Random Access Procedure

[ . . . ]

### 8.1 Random Access Preamble

[ . . . ]

A UE transmits a PRACH on a cell using the selected PRACH format with transmission power P_{PRACH,b,f,c}(i), as described in clause 7.4, on the indicated PRACH resource or on determined N_{preamble}^{rep} resources in case of N_{preamble}^{rep} preamble repetitions.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

8.2 Random access response—Type-1 random access procedure
[ . . . ]

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers.

The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

[ . . . ]

A RAR UL grant schedules a PUSCH transmission from the UE. The contents of the RAR UL grant, starting with the MSB and ending with the LSB, are given in Table 8.2-1.

[ . . . ]

### 8.3 PUSCH Scheduled by RAR UL Grant

An active UL BWP with SCS configuration y, as described in clause 12 and in [4, TS 38.211], for a PUSCH transmission scheduled by a RAR UL grant is indicated by higher layers.

[ . . . ]

Msg3 PUSCH retransmissions, if any, of the transport block, are scheduled by a DCI format 0_0 with CRC scrambled by a TC-RNTI provided in the corresponding RAR message [11, TS 38.321].

8.4 PDSCH with UE Contention Resolution Identity

In response to a PUSCH transmission scheduled by a RAR UL grant when a UE has not been provided a C-RNTI, the UE attempts to detect a DCI format 1_0 with CRC scrambled by a corresponding TC-RNTI scheduling a PDSCH that includes a UE contention resolution identity [11, TS 38.321]. In response to the PDSCH reception with the UE contention resolution identity, the UE transmits HARQ-ACK information in a PUCCH.

[ . . . ]

Furthermore, 3GPP 38.321 states:

### 5.1.2 Random Access Resource Selection

If the selected RA_TYPE is set to 4-stepRA, the MAC entity shall:

[ . . . ]
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
         [ . . . ]
3> if Random Access Preambles group B is configured:
   4> if the potential Msg3 size (UL data available for transmission plus MAC subheader(s) and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—messagePowerOffsetGroupB; or
   4> if the Random Access procedure was initiated for the CCCH logical channel and the CCCH SDU size plus MAC subheader is greater than ra-Msg3SizeGroupA:
      5> select the Random Access Preambles group B.
   4> else:
      5> select the Random Access Preambles group A.
3> else:
   4> select the Random Access Preambles group A.
      [ . . . ]
2> select a Random Access Preamble randomly with equal probability from the Random Access Preambles associated with the selected SSB and the selected Random Access Preambles group;
2> set the PREAMBLE_INDEX to the selected Random Access Preamble.
   [ . . . ]
1> perform the Random Access Preamble transmission procedure (see clause 5.1.3).
   [ . . . ]

### 5.1.4 Random Access Response Reception

Once the Random Access Preamble is transmitted and regardless of the possible occurrence of a measurement gap, the MAC entity shall:

[ . . . ]
1> else:
   2> if the Random Access Preamble was transmitted on a non-terrestrial network:
      3> start the ra-ResponseWindow configured in RACH-ConfigCommon at the PDCCH occasion as specified in TS 38.213 [6].
         [ . . . ]
1> else if a valid (as specified in TS 38.213 [6]) downlink assignment has been received on the PDCCH for the RA-RNTI and the received TB is successfully decoded:
   [ . . . ]
2> if the Random Access Response contains a MAC subPDU with Random Access Preamble identifier corresponding to the transmitted PREAMBLE INDEX (see clause 5.1.3):
   3> consider this Random Access Response reception successful.
2> if the Random Access Response reception is considered successful:
   3> if the Random Access Response includes a MAC subPDU with RAPID only:
      4> consider this Random Access procedure successfully completed;
      4> indicate the reception of an acknowledgement for SI request to upper layers.
   3> else:
      [ . . . ]
6> process the received UL grant value and indicate it to the lower layers.
4> if the Random Access Preamble was not selected by the MAC entity among the contention-based Random Access Preamble(s):
5> consider the Random Access procedure successfully completed.
4> else:
   [ . . . ]
5> if this is the first successfully received Random Access Response within this Random Access procedure:
   [ . . . ]
6> obtain the MAC PDU to transmit from the Multiplexing and assembly entity and store it in the Msg3 buffer.

### 5.1.5 Contention Resolution

Once Msg3 is transmitted the MAC entity shall:

[ . . . ]
1> if notification of a reception of a PDCCH transmission of the SpCell is received from lower layers:
   [ . . . ]
2> else if the CCCH SDU was included in Msg3 and the PDCCH transmission is addressed to its TEMPORARY C-RNTI:
   3> if the MAC PDU is successfully decoded:
      4> stop ra-ContentionResolutionTimer;
      4> if the MAC PDU contains a UE Contention Resolution Identity MAC CE; and
      4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY C-RNTI;
         5> discard the TEMPORARY_C-RNTI;
         5> consider this Random Access procedure successfully completed.

In addition, 3GPP TS 38.331 states:

5.2.2.3.3 Request for on demand system information

The UE shall, while SDT procedure is not ongoing:
1> if SIB1 includes si-Schedulinginfo containing si-RequestConfigSUL and criteria to select supplementary uplink as defined in TS 38.321[3], clause 5.1.1 is met:
   2> trigger the lower layer to initiate the Random Access procedure on supplementary uplink in accordance with TS 38.321 [3] using the PRACH preamble(s) and PRACH resource(s) in si-RequestConfigSUL corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else if the UE is a RedCap UE and if initialUplinkBWP-RedCap is configured in UplinkConfigCommonSIB and if SIB1 includes si-Schedulinginfo containing si-RequestConfigRedCap and criteria to select normal uplink as defined in TS 38.321[3], clause 5.1.1 is met:
   2> trigger the lower layer to initiate the Random Access procedure on normal uplink in accordance with TS 38.321 [3] using the PRACH preamble(s) and PRACH resource(s) in si-RequestConfigRedcap corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else:
   2> if the UE is not a RedCap UE and if SIB1 includes si-Schedulinginfo containing si-RequestConfig and criteria to select normal uplink as defined in TS 38.321[3], clause 5.1.1 is met; or
   2> if the UE is a RedCap UE and if initialUplinkBWP-RedCap is not configured in UplinkConfigCommonSlB and if SIB1 includes si-Schedulinginfo containing si-RequestConfig and criteria to select normal uplink as defined in TS 38.321[3], clause 5.1.1 is met:
      3> trigger the lower layer to initiate the Random Access procedure on normal uplink in accordance with TS 38.321 [3] using the PRACH preamble(s) and PRACH resource(s) in si-RequestConfig corresponding to the SI message(s) that the UE requires to operate within the cell, and for which si-BroadcastStatus is set to notBroadcasting;
      3> if acknowledgement for SI request is received from lower layers:
         4> acquire the requested SI message(s) as defined in clause 5.2.2.3.2, immediately;
            [ . . . ]
NOTE: After RACH failure for SI request it is up to UE implementation when to retry the SI request.

### 5.3.3 RRC Connection Establishment

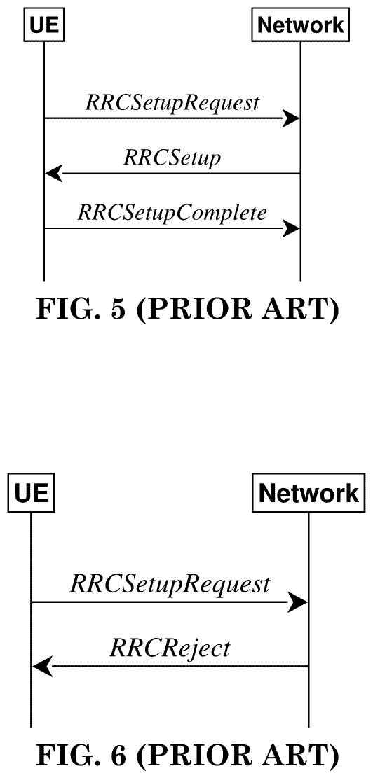

### 5.3.3.1 General

[FIG. 5.3.3.1-1 of 3GPP TS 38.331 V17.6.0, entitled “RRC connection establishment, successful”, is reproduced as FIG. 5]

[FIG. 5.3.3.1-2 of 3GPP TS 38.331 V17.6.0, entitled “RRC connection establishment, network reject”, is reproduced as FIG. 6]

The purpose of this procedure is to establish an RRC connection. RRC connection establishment involves SRB1 establishment. The procedure is also used to transfer the initial NAS dedicated information/message from the UE to the network.

The network applies the procedure e.g. as follows:
When establishing an RRC connection;
When UE is resuming or re-establishing an RRC connection, and the network is not able to retrieve or verify the UE context. In this case, UE receives RRCSetup and responds with RRCSetupComplete.

### 5.3.3.2 Initiation

The UE initiates the procedure when upper layers request establishment of an RRC connection while the UE is in RRC_IDLE and it has acquired essential system information, or for sidelink communication as specified in clause 5.3.3.1a.

The UE shall ensure having valid and up to date essential system information as specified in clause 5.2.2.2 before initiating this procedure.

Upon initiation of the procedure, the UE shall:
1> if the upper layers provide an Access Category and one or more Access Identities upon requesting establishment of an RRC connection:
   2> perform the unified access control procedure as specified in 5.3.14 using the Access Category and Access Identities provided by upper layers;
      3> if the access attempt is barred, the procedure ends;
1> if the upper layers provide NSAG information and one or more S-NSSAI(s) triggering the access attempt (TS 23.501 [32] and TS 24.501 [23]):
   2> apply the NSAG with highest NSAG priority among the NSAGs that are included in SIB1 (i.e., in FeatureCombination and/or in RA-PrioritizationSliceInfo), and that are associated with the S-NSSAI(s) triggering the access attempt, in the Random Access procedure (TS 38.321 [3], clause 5.1);
      [ . . . ]
1> initiate transmission of the RRCSetupRequest message in accordance with 5.3.3.3;

### 5.3.3.3 Actions Related to Transmission of RRCSetupRequest Message

The UE shall set the contents of RRCSetupRequest message as follows:

[ . . . ]
1> if the establishment of the RRC connection is the result of release with redirect with mpsPrioritylndication (either in NR or E-UTRAN):
   2> set the establishmentCause to mps-PriorityAccess;
1> else:

The UE shall submit the RRCSetupRequest message to lower layers for transmission. If the UE is a RedCap UE and the RedCap-specific initial downlink BWP is not associated with CD-SSB, the UE may continue cell re-selection related measurements as well as cell re-selection evaluation, otherwise the UE shall continue cell re-selection related measurements as well as cell re-selection evaluation. If the conditions for cell re-selection are fulfilled, the UE shall perform cell re-selection as specified in 5.3.3.6.

[ . . . ]

### 5.3.3.4 Reception of the RRCSetup by the UE

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
   [ . . . ]
2> release the RRC configuration except for the default L1 parameter values, default MAC Cell Group configuration, CCCH configuration and broadcast MRBs;
2> indicate to upper layers fallback of the RRC connection;
   [ . . . ]
1> perform the cell group configuration procedure in accordance with the received masterCellGroup and as specified in 5.3.5.5;
1> perform the radio bearer configuration procedure in accordance with the received radioBearerConfig and as specified in 5.3.5.6;
1> if stored, discard the cell reselection priority information provided by the cellReselectionPriorities or inherited from another RAT;
   [ . . . ]
1> if the RRCSetup is received in response to an RRCResumeRequest, RRCResumeRequest1 or RRCSetupRequest:
   [ . . . ]
2> enter RRC_CONNECTED;
2> stop the cell re-selection procedure;
   [ . . . ]
1> consider the current cell to be the PCell;
   [ . . . ]
1> set the content of RRCSetupComplete message as follows:
   [ . . . ]
1> submit the RRCSetupComplete message to lower layers for transmission, upon which the procedure ends.

### 5.3.3.5 Reception of the RRCReject by the UE

The UE shall: 1> perform the actions as specified in 5.3.15;

[ . . . ]

### 5.3.13 RRC Connection Resume

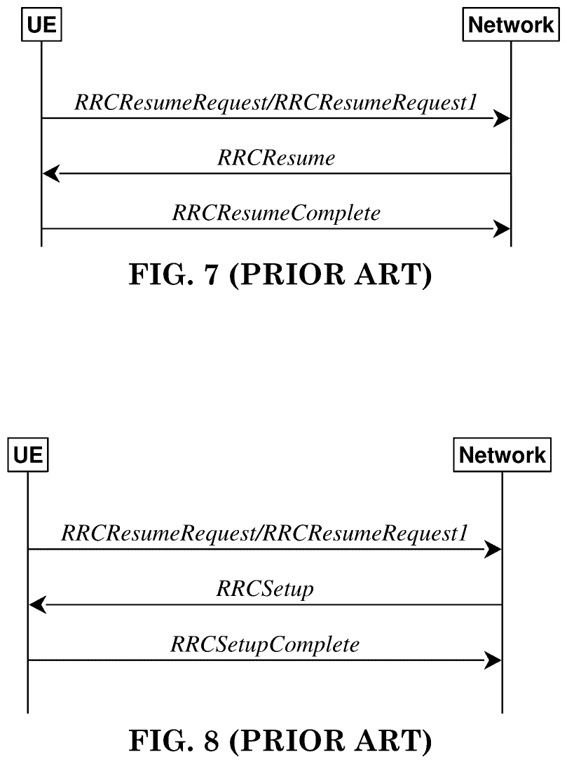

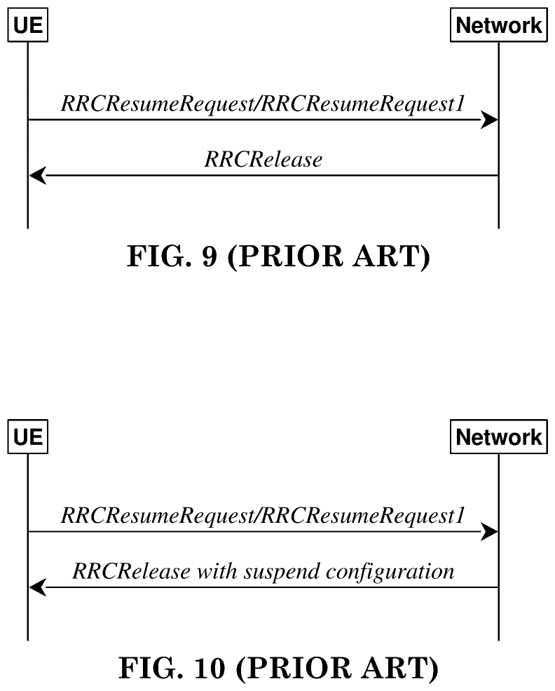

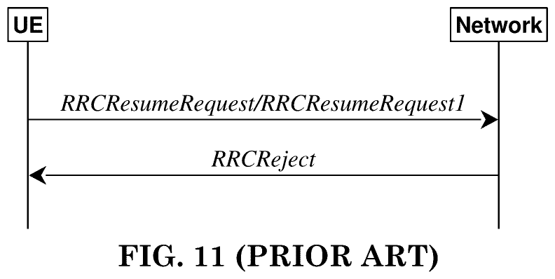

### 5.3.13.1 General

[FIG. 5.3.13.1-1 of 3GPP TS 38.331 V17.6.0, entitled “RRC connection resume, successful”, is reproduced as FIG. 7]

[FIG. 5.3.13.1-2 of 3GPP TS 38.331 V17.6.0, entitled “RRC connection resume fallback to RRC connection establishment, successful” is reproduced as FIG. 8]

[FIG. 5.3.13.1-3 of 3GPP TS 38.331 V17.6.0, entitled “RRC connection resume followed by network release, successful” is reproduced as FIG. 9]

[FIG. 5.3.13.1-4 of 3GPP TS 38.331 V17.6.0, entitled “RRC connection resume followed by network suspend, successful”, is reproduced as FIG. 10]

[FIG. 5.3.13.1-5 of 3GPP TS 38.331 V17.6.0, entitled “RRC connection resume, network reject”, is reproduced as FIG. 11]

The purpose of this procedure is to resume a suspended RRC connection, including resuming SRB(s), DRB(s) and multicast MRB(s) or perform an RNA update. This procedure is also used to initiate SDT in RRC_INACTIVE.

[ . . . ]

### 5.3.13.2 Initiation

[ . . . ]

The UE shall ensure having valid and up to date essential system information as specified in clause 5.2.2.2 before initiating this procedure.

Upon initiation of the procedure, the UE shall:
1> if the resumption of the RRC connection is triggered by response to NG-RAN paging:
   2> select ‘0’ as the Access Category;
   2> perform the unified access control procedure as specified in 5.3.14 using the selected Access Category and one or more Access Identities provided by upper layers;
      3> if the access attempt is barred, the procedure ends;
1> else if the resumption of the RRC connection is triggered by upper layers:
   2> if the upper layers provide an Access Category and one or more Access Identities:
      3> perform the unified access control procedure as specified in 5.3.14 using the Access Category and Access Identities provided by upper layers;
         4> if the access attempt is barred, the procedure ends;
   2> if the upper layers provide NSAG information and one or more S-NSSAI(s) triggering the access attempt (TS 23.501 [32] and TS 24.501 [23]):
      3> apply the NSAG with highest NSAG priority among the NSAGs that are included in SIB1 (i.e., in FeatureCombination and/or in RA-PrioritizationSliceInfo), and that are associated with the S-NSSAI(s) triggering the access attempt, in the Random Access procedure (TS 38.321 [3], clause 5.1);
         [ . . . ]
2> if the resumption occurs after release with redirect with mpsPrioritylndication:
   3> set the resumeCause to mps-PriorityAccess;
2> else:
   3> set the resumeCause in accordance with the information received from upper layers;
1> else if the resumption of the RRC connection is triggered due to an RNA update as specified in 5.3.13.8:
   2> if an emergency service is ongoing:
      [ . . . ]
3> select ‘2’ as the Access Category;
3> set the resumeCause to emergency;
2> else:
3> select ‘8’ as the Access Category;
2> perform the unified access control procedure as specified in 5.3.14 using the selected Access Category and one or more Access Identities to be applied as specified in TS 24.501 [23];
   3> if the access attempt is barred:
      4> set the variable pendingRNA-Update to true;
      4> the procedure ends;
         [ . . . ]
1> initiate transmission of the RRCResumeRequest message or RRCResumeRequest1 in accordance with 5.3.13.3.

### 5.3.13.4 Reception of the RRCResume by the UE

The UE shall:
1> if the RRCResume includes the masterCellGroup:
   2> perform the cell group configuration for the received masterCellGroup according to 5.3.5.5;
      [ . . . ]
1> enter RRC_CONNECTED;
1> indicate to upper layers that the suspended RRC connection has been resumed;
1> stop the cell re-selection procedure;
1> consider the current cell to be the PCell;
1> set the content of the of RRCResumeComplete message as follows:
1> submit the RRCResumeComplete message to lower layers for transmission;
1> the procedure ends.
   5.2.2.4.2 Actions upon reception of the SIB1

Upon receiving the SIB1 the UE shall:
1> store the acquired SIB1;
1> if the access is for NTN, and the cellBarredNTN in the acquired SIB1 is set to barred or the cellBarredNTN is not included in the acquired SIB1:
   2> consider the cell as barred in accordance with TS 38.304 [20];
   2> perform cell re-selection to other cells on the same frequency as the barred cell as specified in TS 38.304 [20];
1> if the UE is a RedCap UE and it is in RRC_IDLE or in RRC_INACTIVE, or if the RedCap UE is in RRC_CONNECTED while T311 is running:
   2> if intraFreqReselectionRedCap is not present in SIB1:
      3> consider the cell as barred in accordance with TS 38.304 [20];
      3> perform barring as if intraFreqReselectionRedCap is set to allowed;
   2> else:
      3> if the cellBarredRedCap1Rx is present in the acquired SIB1 and is set to barred and the UE is equipped with 1 Rx branch; or
      3> if the cellBarredRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred in accordance with TS 38.304 [20];
         4> perform barring based on intraFreqReselectionRedCap as specified in TS 38.304 [20];
1> if the cellAccessRelatedInfo contains an entry of a selected SNPN or PLMN and in case of PLMN the UE is either allowed or instructed to access the PLMN via a cell for which at least one CAG ID is broadcast:
   2> in the remainder of the procedures use npn-IdentityList, trackingAreaCode, and cellidentity for the cell as received in the corresponding entry of npn-IdentityInfoList containing the selected PLMN or SNPN;
1> else if the cellAccessRelatedInfo contains an entry with the PLMN-Identity of the selected PLMN:
   2> in the remainder of the procedures use plmn-IdentityList, trackingAreaCode, trackingAreaList, and cellIdentity for the cell as received in the corresponding PLMN-IdentityInfo containing the selected PLMN;
1> if the UE in RRC_INACTIVE is configured for feature(s) that it does not support in current serving cell:
   2> the corresponding configuration is not used in current serving cell;
      [ . . . ]
1> else:
   2> if the UE supports one or more of the frequency bands indicated in the frequencyBandList for downlink for TDD, or one or more of the frequency bands indicated in the frequencyBandList for uplink for FDD, and they are not downlink only bands, and
   2> if the UE is IAB-MT or supports at least one additionalSpectrumEmission in the NR-NS-PmaxList for a supported band in the downlink for TDD, or a supported band in uplink for FDD, and
   2> if the UE supports an uplink channel bandwidth with a maximum transmission bandwidth configuration (see TS 38.101-1 [15], TS 38.101-2 [39], and TS 38.101-5 [75]) which
      is smaller than or equal to the carrierBandwidth (indicated in uplinkConfigCommon for the SCS of the initial uplink BWP or, for RedCap UE, of the RedCap-specific initial uplink BWP if configured), and which
      is wider than or equal to the bandwidth of the initial uplink BWP or, for RedCap UE, of the RedCap-specific initial uplink BWP if configured, and
   2> if the UE supports a downlink channel bandwidth with a maximum transmission bandwidth configuration (see TS 38.101-1 [15], TS 38.101-2 [39], and TS 38.101-5 [75]) which
      is smaller than or equal to the carrierBandwidth (indicated in downlinkConfigCommon for the SCS of the initial downlink BWP or, for RedCap UE, of the RedCap-specific initial downlink BWP if configured), and which
      is wider than or equal to the bandwidth of the initial downlink BWP or, for RedCap UE, of the RedCap-specific initial downlink BWP if configured, and
   2> if frequencyShift7p5 khz is present and the UE supports corresponding 7.5 kHz frequency shift on this band; or frequencyShift7p5 khz is not present:
      3> if neither trackingAreaCode nor trackingAreaList is provided for the selected PLMN nor the registered PLMN nor PLMN of the equivalent PLMN list:
         4> consider the cell as barred in accordance with TS 38.304 [20];
         4> perform cell re-selection to other cells on the same frequency as the barred cell as specified in TS 38.304 [20];
      3> else if UE is IAB-MT and if iab-Support is not provided for the selected PLMN nor the registered PLMN nor PLMN of the equivalent PLMN list nor the selected SNPN nor the registered SNPN:
         4> consider the cell as barred in accordance with TS 38.304 [20];
      3> else:
         4> apply a supported uplink channel bandwidth with a maximum transmission bandwidth which
         is contained within the carrierBandwidth indicated in uplinkConfigCommon for the SCS of the initial uplink BWP or, for RedCap UEs, RedCap-specific initial uplink BWP, if configured, and which
         is wider than or equal to the bandwidth of the initial BWP for the uplink or, for a RedCap UE, of the RedCap-specific initial uplink BWP if configured;
         4> apply a supported downlink channel bandwidth with a maximum transmission bandwidth which
         is contained within the carrierBandwidth indicated in downlinkConfigCommon for the SCS of the initial downlink BWP or, for RedCap UEs, RedCap-specific initial downlink BWP, if configured, and which
         is wider than or equal to the bandwidth of the initial BWP for the downlink or, for a RedCap UE, of the RedCap-specific initial downlink BWP if configured;
         4> select the first frequency band in the frequencyBandList, for FDD from frequencyBandList for uplink, or for TDD from frequencyBandList for downlink, which the UE supports and for which the UE supports at least one of the additionalSpectrumEmission values in nr-NS-PmaxList, if present;
         4> if the UE supports an uplink channel bandwidth with a maximum transmission bandwidth configuration (see TS 38.101-1 [15] and TS 38.101-2 [39]) which
         is smaller than or equal to the carrierBandwidth (indicated in supplementaryUplink for the SCS of the initial uplink BWP), and which
         is wider than or equal to the bandwidth of the initial uplink BWP of the SUL:
            [ . . . ]
2> else:
   3> consider the cell as barred in accordance with TS 38.304 [20]; and
   3> perform barring as if intraFreqReselection, or intraFreqReselectionRedCap for RedCap UEs, is set to notAllowed;
      [ . . . ]

### SIB1

SIB1 contains information relevant when evaluating if a UE is allowed to access a cell and defines the scheduling of other system information. It also contains radio resource configuration information that is common for all UEs and barring information applied to the unified access control.

```
[...]
  Direction: Network to UE
                                      SIB1 message
-- ASN1START
-- TAG-S1B1-START
SIB1 ::= SEQUENCE {
...
OPTIONAL,  -- Cond Sandalone
    cellAccessRelatedInfo CellAccessRelatedInfo,
    connEstFailureControl ConnEstFailureControl
OPTIONAL,  -- Need R
    si-SchedulingInfo SI-SchedulingInfo
OPTIONAL,  -- Need R
    servingCellConfigCommon ServingCellConfigCommonSIB
OPTIONAL,  -- Need R
    ims-EmergencySupport ENUMERATED {true}
OPTIONAL,  -- Need R
    eCallOverIMS-Support ENUMERATED {true}
OPTIONAL,  -- Need R
    ue-TimersAndConstants UE-TimersAndConstants
OPTIONAL,  -- Need R
    uac-BarringInfo SEQUENCE {
        uac-BarringForCommon UAC-BarringPerCatList
OPTIONAL,  -- Need S
        uac-BarringPerPLMN-List UAC-BarringPerPLMN-List
OPTIONAL,  -- Need S
        uac-BarringInfoSetList UAC-BarringInfoSetList,
        uac-AccessCategory1-SelectionAssistanceInfo CHOICE {
            plmnCommon UAC-AccessCategory1-SelectionAssistanceInfo,
            individualPLMNList SEQUENCE (SIZE (2..maxPLMN) ) OF UAC-
AccessCategory1-SelectionAssistanceInfo
        }
OPTIONAL,  -- Need S
    }
OPTIONAL,  -- Need R
}
...
SIB1-v1630-IEs ::=  SEQUENCE {
    uac-BarringInfo-v1630 SEQUENCE {
        uac-AC1-SelectAssistInfo-r16 SEQUENCE (SIZE (2..maxPLMN) ) OX UAC-AC1-
SelectAssistInfo-r16
    }
OPTIONAL,  -- Need R
    nonCriticalExtension SIB1-v1700-IEs
OPTIONAL
}
SIB1-v1700-IEs ::= SEQUENCE {
    hsdn-Cell-r17 ENUMERATED {true}
OPTIONAL,  -- Need R
    uac-BarringInfo-v1700 SEQUENCE {
        uac-BarringInfoSetList-v1700 UAC-BarringInfoSetList-v1700
    }
OPTIONAL, -- Cond MINT
    sdt-ConfigCommon-r17 SDT-ConfigCommonSIB-r17
OPTIONAL,  -- Need R
    redCap-ConfigCommon-r17 RedCap-ConfigCommonSIB-r17
OPTIONAL,  -- Need R
    featurePriorities-r17 SEQUENCE {
        redCapPriority-r17 FeaturePriority-r17
OPTIONAL,  -- Need R
        slicingPriority-r17 FeaturePriority-r17
OPTIONAL,  -- Need R
        msg3-Repetitions-Priority-r17 FeaturePriority-r17
OPTIONAL,  -- Need R
        sdt-Priority-r17 FeaturePriority-r17
OPTIONAL,  -- Need R
    si-SchedulingInfo-v1700 SI-SchedulingInfo-v1700
OPTIONAL,  -- Need R
    hyperSFN-r17 BIT STRING (SIZE (10))
OPTIONAL,  -- Need R
    eDRX-AllowedIdle-r17 ENUMERATED {true}
OPTIONAL,  -- Need R
    eDRX-AllowedInactive-r17 ENUMERATED {true}
OPTIONAL,  -- Cond BDPX-RC
    intraFreqReselectionRedCap-r17 ENUMERATED {allowed, notAllowed}
OPTIONAL,  -- Need S
    cellBarredNTN-r17 ENUMERATED {barred, notBarred}
OPTIONAL,  -- Need S
...
UAC-AccessCategory1-SelectionAssistanceInfo ::=  ENUMERARED {a, b, c}
UAC-AC1-SelectAssistInfo-r16 ::=  ENUMERARED {a, b, c, notConfigured}
SDT-ConfigCommonSIB-r17 ::=  SEQUENCE {
    sdt-RSRP-Threshold-r17 RSRP-Range
OPTIONAL,  -- Need R
    sdt-LogicalChannelSR-DelayTimer-r17 ENUMERATED { sf20, sf40, sf64, sf128, sf512, sf1024,
sf2560, spare1} OPTIONAL, —-- Need R
    sdt-DataVolumeThreshold-r17 ENUMERATED {byte32, byte100, byte200, byte400, byte600,
byte800, byte1000, byte2000, byte4000,
                                                    byte8000, byte9000, byte10000, byte12000,
byte24000, byte48000, byte96000} ,
    t319a-r17 ENUMERATED { ms100, ms200, ms300, ms400, ms600, ms1000,
ms2000 ,
                                                    ms3000, ms4000, spare7, spare6, spare5,
spare4, spare3, spare2, spare1}
}
RedCap-ConfigCommonSIB-r17 ::= SEQUENCE
    halfDuplexRedCapAllowed-r17  ENUMERATED {true}
OPTIONAL,  -- Need R
    cellBarredRedCap-r17 SEQUENCE
        cellBarredRedCap1Rx-r17 ENUMERATED {barred, notBarred},
        cellBarredRedCap2Rx-r17 ENUMERATED {barred, notBarred},
    }
OPTIONAL,  -- Need R
    . . .
}
FeaturePriority-r17 ::= INTEGER (0..7)
-- TAG-SIB1-STOP
-- ASN1STOP
```

SIB1 field descriptions

cellBarredNTN
Value barred means that the cell is barred for connectivity to NTN, as defined in TS 38.304 [20].
Value notBarred means that the cell is allowed for connectivity to NTN. If not present, the UE
considers the cell is not allowed for connectivity to NTN, as defined in TS 38.304 [20]. This field is
only applicable to NTN-capable UEs.
cellBarredRedCap1Rx
Value barred means that the cell is barred for a RedCap UE with 1 Rx branch, as defined in TS
38.304 [20]. This field is ignored by non-RedCap UEs.
cellBarredRedCap2Rx
Value barred means that the cell is barred for a RedCap UE with 2 Rx branches, as defined in TS
38.304 [20]. This field is ignored by non-RedCap UEs.
cellSelectionInfo
Parameters for cell selection related to the serving cell.
eCallOverIMS-Support
Indicates whether the cell supports eCall over IMS services as defined in TS 23.501 [32]. If absent,
eCall over IMS is not supported by the network in the cell.
eDRX-AllowedIdle
The presence of this field indicates that extended DRX for CN paging is allowed in the cell for UEs
in RRC_IDLE or RRC_INACTIVE. The UE shall stop using extended DRX for CN paging in RRC_IDLE
or RRC_INACTIVE if eDRX-AllowedIdle is not present.
eDRX-AllowedInactive
The presence of this field indicates that extended DRX for RAN paging is allowed in the cell for
UEs in RRC_INACTIVE. The UE shall stop using extended DRX for RAN paging in RRC_INACTIVE if
eDRX-AllowedInactive is not present.
featurePriorities
Indicates priorities for features, such as RedCap, Slicing, SDT and MSG3-Repetitions for Coverage
Enhancements. These priorities are used to determine which FeatureCombinationPreambles the
UE shall use when a feature maps to more than one FeatureCombinationPreambles, as specified
in TS 38.321 [3]. A lower value means a higher priority. The network does not signal the same
priority for more than one feature. The network signals a priority for all feature that map to at
least one FeatureCombinationPreambles.
halfDuplexRedCap-Allowed
The presence of this field indicates that the cell supports half-duplex FDD RedCap UEs.
hsdn-Cell
This field indicates this is a HSDN cell as specified in TS 38.304 [20].
[. . .]
ims-EmergencySupport
Indicates whether the cell supports IMS emergency bearer services for UEs in limited service
mode. If absent, IMS emergency call is not supported by the network in the cell for UEs in limited
service mode.
intraFreqReselectionRedCap
Controls cell selection/reselection to intra-frequency cells for RedCap UEs when this cell is
barred, or treated as barred by the RedCap UE, as specified in TS 38.304 [20]. If not present, a
RedCap UE treats the cell as barred, i.e., the UE considers that the cell does not support RedCap.
[. . .]
uac-AccessCategory1-SelectionAssistanceInfo
Information used to determine whether Access Category 1 applies to the UE, as defined in TS
22.261 [25]. If plmnCommon is chosen, the UAC-AccessCategory1-SelectionAssistanceInfo is
applicable to all the PLMNs and SNPNs in plmn-IdentityInfoList and npn-IdentityInfoList. If
individualPLMNList is chosen, the 1^{st} entry in the list corresponds to the first network within all of
the PLMNs and SNPNs across the plmn-IdentityList and the npn-IdentityInfoList, the 2^{nd} entry in
the list corresponds to the second network within all of the PLMNs and SNPNs across the plmn-
IdentityList and the npn-IdentityInfoList and so on. If uac-AC1-SelectAssistInfo-r16 is present, the
UE shall ignore the uac-AccessCategory1-SelectionAssistanceInfo.
uac-AC1-SelectAssistInfo
Information used to determine whether Access Category 1 applies to the UE, as defined in TS
22.261 [25]. The 1^{st} entry in the list corresponds to the first network within all of the PLMNs and
SNPNs across the plmn-IdentityList and npn-IdentityInfoList, the 2^{nd} entry in the list corresponds
to the second network within all of the PLMNs and SNPNs across the plmn-IdentityList and the
npn-IdentityInfoList and so on. Value notConfigured indicates that Access Category1 is not
configured for the corresponding PLMN/SNPN.
uac-BarringForCommon
Common access control parameters for each access category. Common values are used for all
PLMNs/SNPNs, unless overwritten by the PLMN/SNPN specific configuration provided in uac-
BarringPerPLMN-List. The parameters are specified by providing an index to the set of
configurations (uac-BarringInfoSetList). UE behaviour upon absence of this field is specified in
clause 5.3.14.2.

```
[...]
--  SI-RequestConfig
The IE SI-RequestConfig contains configuration for Msg1 based SI request.
                              SI-RequestConfig information element
-- ASN1START
-- TAG-SI-REQUESTCONFIG-START
SI-RequestConfig ::= SEQUENCE {
    rach-OccasionsSI SEQUENCE {
        rach-ConfigSI RACH-ConfigGeneric,
        ssb-perRACH-Occasion ENUMERATED {oneEighth, oneFourth, oneHalf, one, two,
four, eight, sixteen}
    }
OPTIONAL,  -- Need R
    si-RequestPeriod ENUMBRATED {one, two, four, six, eight, ten, twelve,
sixteen} OPTIONAL,  -- Need R
    si-RequestResources SEQUENCE (SIZE (1..maxSI-Message) ) OF SI-RequestResources
}
SI-RequestResources ::= SEQUENCE {
    ra-PreambleStartIndex INTEGER (0..63) ,
    ra-AssociationPeriodIndex INTEGER (0..15)
OPTIONAL,  -- Need R
    ra-ssb-OccasionMaskIndex INTEGER (0..15)
OPTIONAL,  -- Need R
}
-- TAG-SI-REQUESTCONFIG-STOP
-- ASN1STOP
```

Network energy saving is introduced to save power from base station perspective. Energy could be saved by reducing the transmission/reception occasion(s) in time domain. For example, during a period of time that no transmission/reception is performed, the corresponding hardware component(s) could be turn off completely (e.g. go to deep sleep) so that power consumption is reduced. Therefore, from power saving perspective, it would be more preferred to perform/finish transmission/reception within a certain period (e.g. a condensed period) and turn off transmission/reception outside the certain period (e.g. for a longer period of time). There could be a trade-off that larger latency would be induced since the opportunities to transmit/receive is reduced. Common signal could be a source of an always turn-on signal irrespective of whether there is ongoing traffic. For example, common signal (e.g. SSB (Synchronization Signal Block), SS (Solution Set)/PBCH (Physical Broadcast Channel) block, SIB1, SIB (System Information Block), paging, PRACH (Physical Random Access Channel)) is broadcasted and/or could be used for all UEs in the cell, e.g. including UE not yet access the cell. Therefore, reducing the transmission/reception of common signal would become an attractive solution to network energy saving. More details regarding network energy saving is discussed and provided below in 3GPP RP-234065:

The objectives of the work item are the following:
1. Specify procedures and signaling method(s) to support on-demand SSB SCell operation for UEs in connected mode configured with CA, for both intra-/inter-band CA. [RAN1/2/3/4]
   Specify triggering method(s) (select from UE uplink wake-up-signal using an existing signal/channel, cell on/off indication via backhaul, Scell activation/deactivation signaling)
   Note1: On-demand SSB transmission can be used by UE for at least SCell time/frequency synchronization, L1/L3 measurements and SCell activation, and is supported for FR1 and FR2 in non-shared spectrum.
2. Study procedures and signaling method(s) to support on-demand SIB1 for UEs in idle/inactive mode, including: [RAN1/2/3]
   Triggering method by uplink wake-up-signal using an existing signal/channel.
   Wake-up-signal configuration provisioning to UE
      Note: No modification of SSB will be discussed under this objective
   Information exchange between gNBs at least for the configuration of wake-up signal, if necessary.
   Checkpoint for normative work in RAN #105

As shown and discussed above, non-contention based random access procedure could be used to acquire some system information, e.g. other system information (OSI). OSI is SI other than minimum SI. In other words, OSI could be SI that is not necessary or not essential or not urgent for connecting to the serving cell/base station. Therefore, for requesting OSI, the corresponding Random Access Response (RAR) is used to acknowledge the corresponding preamble is received and the random access could be complete successfully after receiving the RAR.

The base station does not need to identify the UE and/or distinguish why the UE is requesting OSI during such random access procedure (since the PRACH/preamble for such non-contention based random access procedure is shared among (all) UEs). On the other hand, when receiving a request for on-demand SIB1, some more thoughts is required regarding how the base station decides whether to provide the on-demand SIB1, e.g. to turn on the cell or to move to a normal state (e.g. more power consuming), or not, e.g. to keep the cell off or to keep in a power saving state. For example, the base station may not want to provide on-demand SIB1 for some cases (e.g. lower priority/lower necessity/non-critical/non-urgent).

A first general concept of this invention is to transmit information related to purpose/cause/necessity of requesting SIB1 to the base station. The information could be a trigger of requesting SIB1. The information could be a trigger of a Radio Resource Control (RRC) procedure (e.g. RRC connection setup/resume procedure) resulting in requesting SIB1. The information could be an access category and/or an access identity. The information could be a cause of an RRC procedure (e.g. RRC connection setup/resume procedure) resulting in requesting SIB1. The information could be establishmentCause or resumeCause. The information could be a priority (level) of requesting the first system information. The information could be a (QoS of) service (type) and/or traffic (type) triggering an RRC procedure (e.g. RRC connection setup/resume procedure) resulting in requesting SIB1. The information could be indicated via a preamble and/or a PRACH. The information could be indicated via a (dedicated) preamble and/or a (dedicated) PRACH in a non-contention based random access procedure. The non-contention based random access procedure is initiated for acquiring SIB1. Different information (e.g. different purposes/causes/triggers) could be associated with different preambles and/or different PRACHs. By detecting/receiving preamble and/or PRACH, base station could realize/receive the information and make corresponding decision, e.g. whether to provide SIB1 (e.g. in the following) or not.

The base station could indicate the decision in RAR. The UE could decide whether to acquire SIB1 on the serving cell based on RAR. After acquiring SIB1, the UE could initiate another random access procedure, e.g. to set up an RRC connection or resume an RRC connection. The information could be indicated via a Msg3 in a contention based random access procedure. The contention based random access procedure is initiated for requesting SIB1. The contention based random access procedure is not initiated for RRC connection establishment or RRC connection resume. After receiving Msg3, base station could realize/receive the information and make corresponding decision, e.g. whether to provide SIB1 (e.g. in the following) or not. The base station could indicate the decision in Msg4. The UE could decide whether to acquire SIB1 on the serving cell based on Msg 4. After acquiring SIB1, the UE could initiate another random access procedure, e.g. to set up an RRC connection or resume an RRC connection.

A second general concept of this invention is to determine whether a UE is allowed to request SIB1 (e.g. on the current (camped) serving cell) based on a rule(s)/criteria, e.g. subject purpose/cause/necessity/priority of requesting SIB1. The rule/criteria could be predefined. The rule/criteria could be informed to the UE (e.g. from a base station). A base station could inform UE whether it is allowed to request SIB1 (e.g. on the current (camped) serving cell), e.g. subject to purpose/cause/necessity/priority of requesting SIB1. The base station could inform the UE criteria or a rule(s) regarding whether requesting SIB1 is allowed.

The UE determines whether to request SIB1 based on the criteria/rule(s). The mechanism could be similar to access barring. For example, the UE could request SIB1 for some access attempt(s) while could not (or is forbidden to) request SIB1 for some other access attempt(s). The UE could request SIB1 for some access category(s) and/or some access identity(s) while could not (or is forbidden to) request SIB1 for some other access category(s) and/or some other access identity(s). The UE could request SIB1 for some purpose/cause/necessity/priority of requesting SIB1 while could not (or is forbidden to) request SIB1 for some other purpose/cause/necessity/priority of requesting SIB1. The UE could request SIB1 for some cause (e.g. establishmentCause or resumeCause) of an RRC procedure (e.g. RRC connection setup/resume procedure) resulting in requesting SIB1 while could not (or is forbidden to) request SIB1 for some other cause of an RRC procedure (e.g. RRC connection setup/resume procedure) resulting in requesting SIB1.

The UE determines whether to request SIB1 based on access category(s) and/or access identity(s). The UE determines whether to request SIB1 based on purpose/cause/necessity/priority of requesting SIB1. The UE determines whether to request SIB1 based on cause of an RRC procedure (resulting in requesting SIB1). The information (e.g. criteria/rule(s)) could be information related to access barring.

The base station could provide access barring information and/or information related to access barring. The UE could determine whether to request SIB1 based on the information. The information (e.g. criteria/rule(s)) could be indicated in MIB/SSB. The information (e.g. criteria/rule(s)) could be indicated in a dedicated RRC configuration or a dedicated RRC message. The information (e.g. criteria/rule(s)) could be indicated in a release message (e.g. to release RRC connection). The information (e.g. criteria/rule(s)) could be indicated in a SIB1 acquired previously for the serving cell.

The base station could inform the UE case(s)/purpose(s)/cause(s)/necessity(s)/priority(s) when requesting SIB1 is allowed and/or case(s)/purpose(s)/cause(s)/necessity(s)/priority(s) when requesting SIB1 is not allowed, e.g. is forbidden. Since some case(s)/purpose(s)/cause(s)/necessity(s)/priority(s) is forbidden from requesting SIB1 (e.g. due to less urgent/critical), the base station does not send on-demand SIB1 unnecessarily. The UE could select or access another serving cell when requesting SIB1 is not allowed (e.g. on the current (camped) serving cell). The UE could select or access another serving cell for case(s)/purpose(s)/cause(s)/necessity(s)/priority(s) when requesting SIB1 is not allowed (e.g. on the current (camped) serving cell).

The UE could perform cell selection/reselection when requesting SIB1 is not allowed (e.g. on the current (camped) serving cell). The UE could perform cell selection/reselection for case(s)/purpose(s)/cause(s)/necessity(s)/priority(s) when requesting SIB1 is not allowed (e.g. on the current (camped) serving cell). For example, if request on-demand SIB1 is due to an access attempt, while after receiving on-demand SIB1, the access attempt could be barred by the on-demand SIB1 so that the UE could not setup RRC connection for the access attempt. Then the on-demand SIB1 is triggered/transmitted unnecessarily since anyway the UE could not access the serving cell. Also some extra delay is introduced since the UE would wait until receiving on-demand SIB1 and realize it's barred. (e.g. and may then try to access another serving cell, e.g. via cell selection/reselection). With this concept, the UE could directly access another serving cell/perform cell reselection, if/when the access attempt is not allowed to request on-demand SIB1, e.g. rather than wait until receiving on demand SIB1.

A third general concept of this invention is to request SIB1 with randomly selected preamble and/or PRACH. The UE could randomly select preamble and/or PRACH among a set of candidates. The UE could initiate a non-contention-based random access procedure to request SIB1. The UE could initiate a contention-based random access procedure to request SIB1. Note that by detecting multiple candidates, e.g. even for non-contention based random access procedure allow base station to detect/estimate/determine amount/number of UE requesting SIB1. The base station could decide/determine whether to provide on-demand SIB1 based on the amount/number of UE requesting SIB1.

In one embodiment, a UE transmits information to a base station. The UE transmits the information to the base station during request of a first system information. The UE transmits the information to the base station when/if/after/before the UE requests a first system information. The information is related to purpose/cause/necessity of requesting the first system information. The information could be or comprise a trigger of request for the first system information. The information could be or comprise a trigger of an RRC procedure (e.g. RRC connection setup/resume procedure) resulting in request for the first system information. The information could be or comprise an access category and/or an access identity. The information could be or comprise an access category and/or an access identity related to an RRC procedure (e.g. RRC connection setup/resume procedure) resulting in or triggering request for the first system information. The information could be or comprise an access category and/or an access identity provided by upper layer for an RRC procedure (e.g. RRC connection setup/resume procedure) resulting in or triggering request for the first system information. The information could be or comprise a cause of an RRC procedure (e.g. RRC connection setup/resume procedure) resulting in or triggering request for the first system information. The information could be or comprise establishmentCause or resumeCause. The information could be or comprise a priority (level) of requesting the first system information. The information could be or comprise amount of data/traffic (e.g. available). The information could be or comprise (e.g. available) data/traffic amount of service resulting in or triggering request for the first system information.

The information could be or comprise QoS (related) information. The information could be or comprise QoS (related) information of service resulting in or triggering request for the first system information. The information could be or comprise a (QoS of) service (type) and/or traffic (type) triggering an RRC procedure (e.g. RRC connection setup/resume procedure) resulting in or triggering request for the first system information. The information could be indicated via a preamble and/or a PRACH. The information could be indicated via a (dedicated) preamble and/or a (dedicated) PRACH in a non-contention based random access procedure. The non-contention based random access procedure is initiated for acquiring SIB1. Different information (e.g. different purposes/causes/triggers) could be associated with different preambles and/or different PRACHs.

The UE determines preamble and/or PRACH based on the information. The UE determines preamble and/or PRACH based on the information to be provided. The UE determines preamble and/or PRACH based on the purposes/causes/triggers/priorities. The UE receives RAR from the base station. The RAR could indicate whether the first system information is (to be) provided or not. The UE could decide whether to acquire the first system information on the serving cell based on RAR. The UE decides to acquire the first system information on the serving cell if/when RAR indicates that the first system information is (to be) provided. The UE decides not to acquire the first system information on the serving cell if/when RAR indicates that the first system information is not (to be) provided.

The UE accesses another serving cell if/when RAR indicates that the first system information is not (to be) provided. The UE performs cell selection/reselection if/when RAR indicates that the first system information is not (to be) provided. The UE could acquire the first system information via RAR. The UE could acquire the first system information via broadcasted message after receiving RAR. After acquiring the first system information, the UE could initiate a second (e.g. another) random access procedure, e.g. to set up an RRC connection or resume an RRC connection. The information could be indicated via a Msg3 in a contention based random access procedure.

The UE transmits a preamble randomly selected from a set of preamble candidates. The UE receives an RAR in response to transmission of the preamble. The RAR indicates an UL grant. The UE transmits the information with the UL grant. The UE includes the information in a transmission based on the UL grant. The contention based random access procedure is initiated for requesting the first system information. The contention based random access procedure is initiated only for requesting the first system information. The contention based random access procedure is not initiated for RRC connection establishment or RRC connection resume.

The base station could determine whether to provide the first system information (e.g. in the following) or not based on the information. The base station could indicate whether to provide the first system information (e.g. in the following) or not in Msg4. The UE could determine whether to acquire SIB1 on the serving cell or not based on Msg 4. The UE determines to acquire the first system information on the serving cell if/when Msg4 indicates that the first system information is (to be) provided (e.g. in the following).

The UE determines not to acquire the first system information on the serving cell if/when Msg4 indicates that the first system information is not (to be) provided (e.g. in the following). The UE accesses another serving cell if/when Msg4 indicates that the first system information is not (to be) provided (e.g. in the following). The UE performs cell selection/reselection if/when Msg4 indicates that the first system information is not (to be) provided (e.g. in the following).

The UE could acquire the first system information via Msg4. The UE could acquire the first system information via broadcasted message after receiving Msg4. After acquiring the first system information, the UE could initiate a second (e.g. another) random access procedure, e.g. to set up an RRC connection or resume an RRC connection. The first system information could be SIB1. The first system information could be essential system information. The first system information could be SSB/MIB. The first system information could be SSB/MIB on another serving cell.

In another embodiment, a UE determines whether (it is allowed) to request a first information on/for a cell based on a rule(s)/criteria. The rule(s)/criteria could be related to or could be purpose/cause/necessity/priority/trigger of requesting the first information. The UE determines whether (it is allowed) to request a first information based on purpose/cause/necessity/priority/trigger of requesting the first information. The UE determines to request a first information based on a first purpose/cause/necessity/priority/trigger. The UE determines not to request a first information based on a second purpose/cause/necessity/priority/trigger. The UE determines to access a second cell based on a second purpose/cause/necessity/priority/trigger. The UE determines to perform cell selection/reselection based on a second purpose/cause/necessity/priority/trigger. The rule(s)/criteria could be related to or could be access barring (related) information.

The UE determines whether (it is allowed) to request a first information based on access barring (related) information. The UE determines to request a first information based on a first access barring (related) information. The UE determines not to request a first information based on a second access barring (related) information. The UE determines to access a second cell based on a second access barring (related) information. The UE determines to perform cell selection/reselection based on a second access barring (related) information. The access barring (related) information could be one or more of: cellBarredNTN, intraFreqReselectionRedCap, cellBarredRedCap1Rx, cellBarredRedCap2Rx, halfDuplexRedCapAllowed, cellAccessRelatedInfo, carrierBandwidth, frequencyBandList, uac-BarringInfo, uac-BarringForCommon, uac-BarringPerPLMN-List, uac-BarringInfoSetList, and/or a type of UE, e.g. RedCap or NTN.

The UE determines whether (it is allowed) to request a first information based on access category(s) and/or access identity. The UE determines to request a first information based on a first access category(s) and/or a first access identity. The UE determines not to request a first information based on a second access category(s) and/or a second access identity. The UE determines to access a second cell based on a second access category(s) and/or a second access identity. The UE determines to perform cell selection/reselection based on a second access category(s) and/or a second access identity. The UE determines whether (it is allowed) to request a first information based on a cause of a RRC procedure (e.g. RRC connection setup/resume procedure). The UE determines to request a first information based on a first cause of a RRC procedure. The UE determines not to request a first information based on a second cause of a RRC procedure. The UE determines to access a second cell based on a second cause of a RRC procedure. The UE determines to perform cell selection/reselection based on a second cause of a RRC procedure. The UE determines whether (it is allowed) to request a first information based on establishmentCause or resumeCause. The UE determines to request a first information based on a first (value of) establishmentCause or a first (value of) resumeCause.

The UE determines not to request a first information based on a second (value of) establishmentCause or a second (value of) resumeCause. The UE determines to access a second cell based on a second (value of) establishmentCause or a second (value of) resumeCause. The UE determines to perform cell selection/reselection based on a second (value of) establishmentCause or a second (value of) resumeCause.

The RRC procedure could trigger or initiate request for the first system information. The rule(s) or criteria could be predefined. The rule(s) or criteria could be provided by a base station/network to the UE. The rule(s) or criteria could be provided or indicated by a signal from the base station to the UE. The signal could be SSB. The signal could be MIB. The signal could be SIB1 (e.g. acquired previously). The signal could be (dedicated) RRC message (e.g. received last time in RRC connected state). The signal could be a RRC release message. The signal could be a RRC reconfiguration message.

The UE receives information related to the rule(s) or criteria from a base station/network. The first system information could be SIB1. The first system information could be essential system information. The first system information could be Synchronization Signal Block (SSB)/Master Information Block (MIB). The first system information could be SSB/MIB on another serving cell.

In another embodiment, a UE initiates a random access procedure to request a first system information on a serving cell. The random access procedure is a contention based random access procedure. The UE selects a preamble from a set of preamble candidate(s). The UE randomly selects a preamble from a set of preamble candidate(s).

The base station detects the set of preambles. The base station could estimate/determine a number of UE requesting the first system information, e.g. base on detection of the set of preambles. The base station could determine whether to provide the first system information (e.g. in the following) based on detection of the set of preambles. The base station could determine to provide the first system information (e.g. in the following) if/when a large number (e.g. more than a threshold) of preambles is detected. The base station could determine not to provide the first system information (e.g. in the following) if/when a small number (e.g. less than a threshold) of preambles is detected. The base station could determine whether to provide the first system information (e.g. in the following) based on the number of UE requesting the first system information. The base station could determine to provide the first system information (e.g. in the following) if/when a large number (e.g. more than a threshold) of UE(s) is requesting the first system information. The base station could determine not to provide the first system information (e.g. in the following) if/when a small number (e.g. less than a threshold) of UE(s) is requesting the first system information. The base station could indicate whether to provide the first system information (e.g. in the following) in RAR.

The UE receives an random access response to the preamble. The UE considers the contention based random access procedure complete successfully when/if the RAR is received. The RAR provides an UL grant. The RAR does not provide an UL grant. The UE transmits based on the UL grant. The UE does not transmit based on the UL grant. The RAR could indicate whether the first system information is (to be) provided or not.

The UE could decide whether to acquire the first system information on the serving cell based on RAR. The UE decides to acquire the first system information on the serving cell if/when RAR indicates that the first system information is (to be) provided. The UE decides not to acquire the first system information on the serving cell if/when RAR indicates that the first system information is not (to be) provided. The UE accesses another serving cell if/when RAR indicates that the first system information is not (to be) provided. The UE performs cell selection/reselection if/when RAR indicates that the first system information is not (to be) provided.

The UE could acquire the first system information via RAR. The UE could acquire the first system information via broadcasted message after receiving RAR. After acquiring the first system information, the UE could initiate a second (e.g. another) random access procedure, e.g. to set up a RRC connection or resume a RRC connection. The first system information could be SIB1. The first system information could be essential system information. The first system information could be SSB/MIB. The first system information could be SSB/MIB on another serving cell.

The first system information could be SIB1. The first system information could be MIB. The first system information could be MIB for another serving cell, e.g. Secondary Cell (SCell). The UE initiates a random access procedure to request a first system information when/if the first system information is (e.g. currently) not provided (e.g. in a serving cell and or in a Primary Cell (PCell) of a base station).

After the random access procedure is initiated, the UE transmits a preamble on a serving cell to a base station. The UE receives a random access response from the base station. The random access response indicates whether the first system information would be provided (e.g. in the following) or not. The random access response indicates whether the request is accepted or rejected. The random access response indicates whether the request is accepted or not. The random access response indicates whether the base station or the serving cell would wake up or not. The random access response indicates whether the base station or the serving cell would wake up or remain sleep.

The UE determines whether to acquire/receive/monitor the first system information (or Physical Downlink Control Channel (PDCCH) scheduling the first system information) or not based on indication in the random access response. The UE acquires or attempts to receive the first system information (e.g. on the serving cell) when/if the random access response indicates the first system information would be provided. The UE acquires or attempts to receives the first system information (e.g. on the serving cell) when/if the random access response indicates the request is accepted. The UE acquires or attempts to receive the first system information (e.g. on the serving cell) when/if the random access response indicates the base station or the serving cell would wake up.

The UE does not acquire or does not attempt to receive the first system information (e.g. on the serving cell) when/if the random access response indicates the first system information would not be provided (in the following). The UE does not acquire or does not attempt to receive the first system information (e.g. on the serving cell) when/if the random access response indicates the request is rejected or not accepted. The UE does not acquire or does not attempt to receives the first system information (e.g. on the serving cell) when/if the random access response indicates the base station or the serving cell would remain sleep or would not wake up.

The UE determines whether to access the serving cell or not based on indication in the random access response. (to access the serving cell could mean to set up a (RRC) connection to the serving cell). The UE accesses the serving cell when/if the random access response indicates the first system information would be provided. The UE accesses the serving cell when/if the random access response indicates the request is accepted. The UE accesses the serving cell when/if the random access response indicates the base station or the serving cell would wake up. The UE does not access the serving cell when/if the random access response indicates the first system information would not be provided (in the following). The UE does not access the serving cell when/if the random access response indicates the request is rejected or not accepted. The UE does not access the serving cell when/if the random access response indicates the base station or the serving cell would remain sleep or would not wake up.

The UE accesses another serving cell (different form the serving cell) when/if the random access response indicates the first system information would not be provided (in the following). The UE accesses another serving cell (different form the serving cell) when/if the random access response indicates the request is rejected or not accepted. The UE accesses another serving cell (different form the serving cell) when/if the random access response indicates the base station or the serving cell would remain sleep or would not wake up.

The UE performs cell selection or cell reselection when/if the random access response indicates the first system information would not be provided (in the following). The UE performs cell selection or cell reselection when/if the random access response indicates the request is rejected or not accepted. The UE performs cell selection or cell reselection when/if the random access response indicates the base station or the serving cell would remain sleep or would not wake up.

The UE initiates a second random access procedure for requesting a second system information. The second system information is system information other than SIB1. The second system information is OSI. The second system information is system information scheduled by SIB1.

The UE transmits a (second) preamble to requesting the second system information. The UE receives a (second) random access response from the base station in response to the (second) preamble. The second random access response indicates the (second) preamble or the request is received successfully. The second random access response does not indicate whether the second system information would be provided (e.g. in the following) or not. The second random access response does not indicate whether the request is accepted or rejected. The second random access response does not indicate whether the request is accepted or not. The second random access response does not indicate whether the base station or the serving cell would wake up or not. The second random access response does not indicate whether the base station or the serving cell would wake up or remain sleep. Note that “does not indicate” could mean the corresponding indication is absent.

The UE acquires/receives/monitors the second system information (or PDCCH scheduling the second system information) as long as the second random access response is received. The UE does not determine whether to acquire/receive/monitor the second system information (or PDCCH scheduling the second system information) or not based on indication in the second random access response. The UE does not determine whether to access the serving cell or not based on indication in the second random access response. The UE does not determine whether to access another serving cell or not based on indication in the second random access response. The UE does not determine whether to perform cell reselection or not based on indication in the second random access response.

The UE receives an indication regarding a first system information is provided on which beam and/or a first system information associated with which SSB (index), e.g. SSB 0, SSB1, . . . is provided. The first system information could be SIB1. The first system information could be MIB. The first system information could be MIB of another serving cell (e.g. SCell).

The UE receives the indication regarding the first system information is provided on which beam and/or the first system information associated with which SSB (index) is provided after requesting the first system information. The indication is indicated in an RAR. The indication is indicated in an SSB. The indication could be indicated together and/or jointly with an indication of whether the first system information would be provided or not. The indication could be indicated together and/or jointly with an indication of whether the base station would wake up or not. The indication could be indicated together and/or jointly with an indication of whether request is accepted or not. The indication could indicate whether the first system information is provided on a (specific/corresponding) beam or not and/or whether the first system information associated with a (specific/corresponding) SSB is provided or not. The (specific/corresponding) beam and/or the (specific/corresponding) SSB could be a beam and/or an SSB utilized and/or selected during a random access procedure (e.g. to request the first system information). The (specific/corresponding) beam and/or the (specific/corresponding) SSB could be a beam and/or an SSB associated with a PRACH utilized/selected in a random access procedure (e.g. to request the first system information).

The indication could indicate whether the first system information is provided on each beam of a plurality of beams or not and/or whether the first system information associated with each SSB of a plurality of SSBs is provided or not. For example, the indication could be a bitmap where each bit associated with one beam and/or one SSB. The indication could be a bitmap where each bit associated with a set of one or more beam(s) and/or a set of one or more SSB(s).

The indication could indicate whether the first system information is provided on a plurality of beams or not and/or whether the first system information associated with a plurality of SSBs is provided or not. The plurality of beams and/or the plurality of SSBs could be all beams and/or all SSBs of a cell. The plurality of beams and/or the plurality of SSBs could be a subset of beams and/or a subset of SSBs of a cell.

Prior to initiate a random access procedure to request the first information, the UE could determine whether the first system information is provided by corresponding SSB(s) or not. Corresponding SSB(s) could be SSB with the best quality or with the strongest received power. Corresponding SSB(s) could be SSB(s) which could be received by the UE. Corresponding SSB(s) could be SSB to be selected for random access procedure. When/if the first system information associated with corresponding SSB(s) is provided, the UE does not initiate random access procedure to request the first system information. When/if the first system information associated with corresponding SSB(s) is not provided, the UE initiates random access procedure to request the first system information.

The UE receives an indication regarding a first system information is provided on which time occasion(s) and/or a first system information is provided with which periodicity and/or which offset and/or a first system information is scheduled by which search space. The periodicity of the first system information could be different from a periodicity of SSB. The periodicity of the first system information could be larger than a periodicity of SSB. The periodicity of the first system information could be a multiple times of a periodicity of SSB. For example, the indication could indicate the multiple.

The periodicity and/or the offset could be relative to time occasion(s) of SSB. SSB (e.g. SSB 0 or SSB1) would be transmitted periodically with a periodicity. SIB1 is provided in some SSB occasion(s) of an SSB (e.g. SSB 0 or SSB1) and is not provided in some other SSB occasion(s). For example, when the periodicity of the first system information is 4 times of SSB, the first system information associated with only one SSB occasion out of four consecutive periodic SSB occasions (e.g. each separated by SSB periodicity) is provided and the first system information associated with the other three SSB occasions out of four consecutive periodic SSB occasions is not provided.

The periodicity and/or the offset could indicate the first system information is provided within which SSB period of a SSB (e.g. SSB 0 or SSB1). The periodicity and/or the offset could indicate the first system information is not provided within which SSB period of a SSB (e.g. SSB 0 or SSB1). The first system information could be SIB1.

The first system information could be MIB. The first system information could be MIB of another serving cell (e.g. SCell). The indication could be provided in RAR. The indication could be provided in RAR in response to preamble requesting SIB1. The indication could be provided in SSB. There could be multiple occasion(s)/periodicity(s)/offset(s)/search space(s) configured, e.g. by RRC message. The indication indicates one out of the multiple values.

The indication could be indicated together with indication of whether base station would provide the first system information. The indication could be indicated separately from indication of whether base station would provide the first system information. The indication could be indicated together and/or jointly with an indication of whether the first system information would be provided or not. The indication could be indicated together and/or jointly with an indication of whether the base station would wake up or not. The indication could be indicated together and/or jointly with an indication of whether request is accepted or not. The indication could indicate another time occasion and/or another search space provided in SSB/MIB is not applicable (e.g. currently). The indication could indicate time occasion and/or search space overriding another time occasion and/or another search space provided in SSB/MIB. The UE monitors/receives/acquires the first system information based on the indicated time occasion and/or search space and/or periodicity and/or offset.

Note that the invention is described based on a 4-step random access procedure, while could be adopted or extended to a 2-step random access procedure by merging Msg1 and Msg3 to form a Msg A and by merging Msg2 (e.g. RAR) and Msg4 (e.g. contention resolution) to form Msg B (with some possible extension/adjustment).

Throughout the invention, the invention describes behavior or operation of a single serving cell unless otherwise noted.

Throughout the invention, the invention describes behavior or operation of multiple serving cells unless otherwise noted.

Throughout the invention, the invention describes behavior or operation of a single bandwidth part unless otherwise noted.

Throughout the invention, a base station configures multiple bandwidth parts to the UE unless otherwise noted.

Throughout the invention, a base station configures a single bandwidth part to the UE unless otherwise noted.

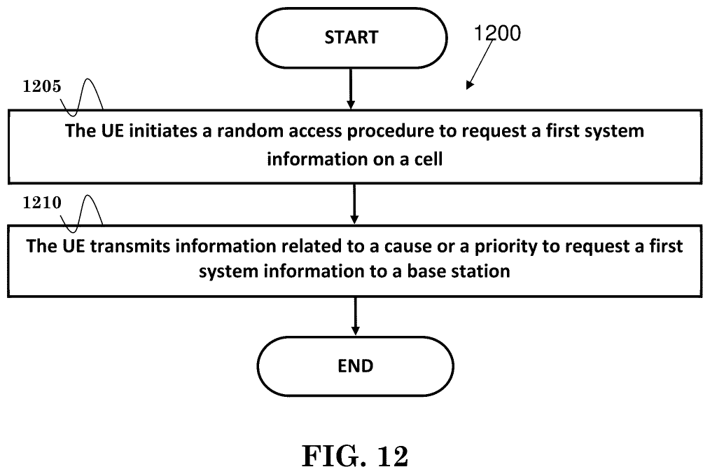

FIG. 12 is a flow chart 1200 for a User Equipment (UE). In step 1205, the UE initiates a random access procedure to request a first system information on a cell. In step 1210, the UE transmits information related to a cause or a priority to request a first system information to a base station.

In one embodiment, the first system information could be SIB1. The information could be used for the base station to determine whether to provide the first system information or not. The information could be transmitted via a Msg 1 or a preamble. The information could be transmitted via a Msg 3. The information could be an access category and/or an access identity. In particular, the information could be an access category and/or an access identity of an access attempt triggering request of the first system information. The information could be a cause of a RRC procedure. The cause could be establishmentCause or resumeCause.

In one embodiment, the RRC procedure could be a RRC connection establishment procedure or a RRC connection resume procedure. The first system information could be requested due to initiation of the RRC procedure.

In one embodiment, the UE could receive indication regarding whether the first system information is provided or not. The UE could determine whether to acquire the first system information or not based on the first system information. The UE could determine whether to perform cell selection/reselection based on the first system information.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information on a cell, and (ii) to transmit information related to a cause or a priority to request a first system information to a base station. Furthermore, the CPU 308 can execute the program code 312 to perform all of the above-described actions and steps or others described herein.

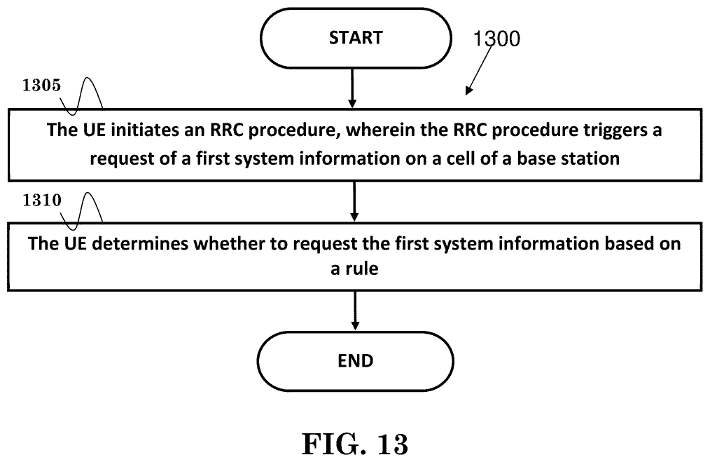

FIG. 13 is a flow chart 1300 for a User Equipment (UE). In step 1305, the UE initiates an RRC procedure, wherein the RRC procedure triggers a request of a first system information on a cell of a base station. In step 1310, the UE determines whether to request the first system information based on a rule.

In one embodiment, the rule could be predefined or fixed. The rule could be indicated by the base station to the UE. The rule could be based on a cause of the RRC procedure. The rule could be based on an access category and/or an access identity. The rule could be based on a priority of the request for the first system information. The rule could be based on amount of data or traffic of a service initiating the RRC procedure. The rule could be based on a QoS of a service initiating the RRC procedure.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate an RRC procedure, wherein the RRC procedure triggers a request of a first system information on a cell of a base station, and (ii) to determine whether to request the first system information based on a rule. Furthermore, the CPU 308 can execute the program code 312 to perform all of the above-described actions and steps or others described herein.

As shown and discussed above, non-contention based random access procedure could be used to acquire some system information, e.g. other system information (OSI). OSI is SI other than minimum SI. In other words, OSI could be SI that is not necessary or not essential or not urgent for connecting to the serving cell/base station. Therefore, for requesting OSI, the corresponding RAR is used to acknowledge the corresponding preamble is received and the random access could be complete successfully after receiving the RAR. The base station does not need to identify the UE during such random access procedure (since the PRACH/preamble for such non-contention based random access procedure is shared among (all) UEs). On the other hand, when requesting on-demand SIB1, the UE may want to set up a connection to the cell/base station. Therefore, the UE may need to firstly initiate a random access procedure to request SIB1.

After finishing the request, the UE would acquire SIB1 by monitoring System Information Radio Network Temporary Identifier (SI-RNTI) and receiving the corresponding scheduled SIB1. After the SIB1 is acquired, the UE initiates another random access procedure to setup/resume the Radio Resource Control (RRC) connection between the cell and the UE. There would be quite some delay since there would involve two random access procedures and one System Information Block (SIB), e.g. SIB1, acquisition procedure.

A first general concept of this invention is to use a single random access procedure to request SIB1 and to setup/resume RRC connection. The random access procedure could be a contention-based random access procedure. There are more than one preamble(s) and/or PRACH resources associated with request for the system information. The more than one preamble(s) and/or PRACH resources could be associated with RRC connection setup/resume. These preamble(s) and/or PRACH(s) could be indicative of the UE is requesting SIB1 and/or set up/resume RRC connection.

The UE selects a preamble (e.g. among several/all candidates) and transmits the preamble to the base station. The UE receives random access response in response to transmission of the preamble. The random access response could indicate acknowledge of reception of the SI request. The random access response could indicate SIB1 is (to be) provided (e.g. in the following). The random access response could indicate an Uplink (UL) grant for Msg3. The UL grant is used for UE to transmit its identity. The UL grant is used for UE to transmit a message for requesting RRC connection setup or a message for requesting RRC connection resume (e.g. RRCSetupRequest/RRCResumeRequest/RRCResumeRequest1).

The UE transmits a message for requesting RRC connection setup or a message for requesting RRC connection resume to the base station (e.g. in Msg3 and/or with the UL grant and/or within the random access procedure). The UE receives response to the request message (e.g. RRCSetup/RRCResume/RRC Reject, e.g. in Msg4 and/or in a contention resolution).

The UE transmits a complete message, e.g.

RRCSetupComplete/RRCResumeComplete, after the (single) random access procedure. The UE finishes RRC setup procedure/RRC resume procedure after the (single) random access procedure. The UE enters RRC connected state after the (single) random access procedure. The UE acquires SIB1 via broadcasted message (e.g. scheduled by Downlink Control Information (DCI) scrambled with SI-RNTI). The UE acquires SIB1 via broadcasted message after the (single) random access procedure. The UE acquires SIB1 via dedicated RRC message (e.g. scheduled by DCI scrambled with C-RNTI/TC-RNTI). The UE acquires SIB1 via dedicated RRC message during or after the (single) random access procedure. The UE acquires SIB1 via RAR. The UE acquires SIB1 via Msg4. The UE acquires SIB1 during the (single) random access procedure. The UE acquires SIB1 after the (single) random access procedure.

The more than one preamble(s) and/or PRACH resources could be different from preamble/PRACH used for/to initiate random access procedure when/if SIB1 is provided. A first (set of) PRACH configuration is used for/to initiate random access procedure when SIB1 is provided. A first (set of) PRACH configuration is used for/to initiate random access procedure when the random access procedure is for RRC connection setup and/or RRC connection resume. A first (set of) PRACH configuration is used for/to initiate random access procedure when the random access procedure is for RRC connection setup and/or RRC connection resume and is not for requesting SIB1. A first (set of) PRACH configuration is used for/to initiate random access procedure when the random access procedure is only for RRC connection setup and/or RRC connection resume. A second (set of) PRACH configuration is used for/to initiate random access procedure when SIB1 is not provided. A second (set of) PRACH configuration is used for/to initiate random access procedure when SIB1 is not provided. A second (set of) PRACH configuration is used for/to initiate random access procedure when the random access procedure is for RRC connection setup (and/or RRC connection resume) and is for requesting SIB1. A second (set of) PRACH configuration is used for/to initiate random access procedure when the random access procedure is both for RRC connection setup (and/or RRC connection resume) and for requesting SIB1. Since a single random access procedure could fulfill the purpose of requesting SIB1 and setup/resume connection, the latency could be reduced, e.g. compared with initiating two separate random access procedures.

A second general concept of this invention is to provide (on-demand) SIB1 to UE on a message (or Physical Downlink Shared Channel (PDSCH)) related to random access procedure (e.g. RAR or Msg4) or a dedicated RRC message. The UE initiate a random access procedure to request SIB1. The SIB1 is provided in response to a request from the UE. SIB1 could be provided on more than one messages/occasions to reduce the latency of accessing a cell.

In response to SIB1 request, the base station provides SIB1 in a RAR or a Msg4 or a dedicated RRC message. The base station provides SIB1 during the random access procedure. The base station provides SIB1 after the random access procedure. In response to SIB1 request, the base station provides SIB1 in a broadcast message (or PDSCH) (e.g. scheduled by DCI scrambled with SI-RNTI). In response to SIB1 request, the base station provides SIB1 in a broadcast message after the random access procedure. The base station provides SIB1 both in a message (or PDSCH) related to random access procedure and in a broadcasted message (or PDSCH). The base station provides SIB1 either in a message (or PDSCH) related to random access procedure or in a broadcasted message (or PDSCH). The base station indicates SIB1 is provided in a message (or PDSCH) related to random access procedure and/or in a broadcasted message (or PDSCH). The base station provides SIB1 both in a dedicated RRC message and in a broadcasted message (or PDSCH). The base station provides SIB1 either in a dedicated RRC message related to random access procedure or in a broadcasted message (or PDSCH). The base station indicates SIB1 is provided in a dedicated RRC message and/or in a broadcasted message (or PDSCH). Since SIB1 could be provided in multiple/different timing, the latency to acquire SIB1 and setup/resume connection could be reduced.

In one embodiment, a UE initiates a random access procedure to request a first system information on a serving cell. The UE initiates the random access procedure to setup or resume a (RRC) connection. The first system information could be essential system information. The UE initiates the random access procedure to setup or resume a (RRC) connection without valid or up to date first system information. The UE initiates the random access procedure to setup or resume a (RRC) connection without valid or up to date essential system information. The UE initiates RRC procedure to setup or resume a (RRC) connection without valid or up to date first system information. The UE initiates RRC procedure to setup or resume a (RRC) connection without valid or up to date essential system information. The UE initiates RRC procedure to setup or resume a (RRC) connection without valid or up to date first system information if/when the first system information is on-demand. The UE initiates RRC procedure to setup or resume a (RRC) connection without valid or up to date essential system information if/when essential system information is on-demand.

The UE does not initiate RRC procedure to setup or resume a (RRC) connection without valid or up to date first system information if/when the first system information is not on-demand, e.g. is provided periodically or normally. The UE does not initiate RRC procedure to setup or resume a (RRC) connection without valid or up to date essential system information if/when essential system information is not on-demand, e.g. is provided periodically or normally.

The UE initiates RRC procedure to setup or resume a (RRC) connection after/when/if valid or up to date first system information is available if/when the first system information is not on-demand, e.g. is provided periodically or normally. The UE initiate RRC procedure to setup or resume a (RRC) connection after/when/if valid or up to date essential system information is available if/when essential system information is not on-demand, e.g. is provided periodically or normally. The UE initiates the random access both to request the first system information and to setup or resume the (RRC) connection. The random access procedure is or could be a contention based random access procedure. The random access procedure is not allowed to be or could not be a non-contention based random access procedure.

The UE selects a preamble and/or PRACH (e.g. among several/all candidates) and transmits the preamble to the base station. The preamble and/or PRACH could be indicative of the UE is requesting the first system information and/or set up/resume RRC connection. An indication in Master Information Block (MIB)/Synchronization Signal Block (SSB) is indicative of whether and/or how UE could request the first system information.

The UE determines whether to initiate the random access procedure based on the indication. The UE determines whether to access/select another cell based on the indication. The UE determines whether to perform cell selection/reselection based on the indication. The UE receives random access response in response to transmission of the (selected) preamble an/or the (selected) PRACH. The random access response could indicate acknowledge of reception of the request for the first system information. The random access response could indicate whether the request (for the first system information) is accepted or not (e.g. rejected). The random access response could comprise (all or part of) the first system information. The random access response could comprise information included in or provided in the first system information.

The UE could continue to access the serving cell if/when the request is accepted. The UE could access another serving cell if/when the request is not accepted or rejected. The UE could perform cell selection/re-selection if/when the request is not accepted or rejected. The random access response could indicate whether the first system information is (to be) provided (e.g. in the following) or not. The random access response could provide the first system information. The random access response could indicate an UL grant for Msg3.

The UL grant is used for UE to transmit its identity or identification. The UL grant is used for UE to transmit a message for requesting RRC connection setup or a message for requesting RRC connection resume (e.g. RRCSetupRequest/RRCResumeRequest/RRCResumeRequest1). The UL grant is used for UE to transmit information related to a cause/purpose of the request. The UL grant is used for UE to transmit information for the base station to determine whether to turn on the serving cell. The UL grant is used for UE to transmit information for the base station to determine whether to provide the first system information for the serving cell. The UL grant is used for UE to transmit information for the base station to determine whether to broadcast the first system information for the serving cell.

The UE transmits a message for requesting RRC connection setup or a message for requesting RRC connection resume to the base station (e.g. in Msg3 and/or with the UL grant and/or within the random access procedure). The UE transmits information related to a cause/purpose of the request (e.g. in Msg3 and/or with the UL grant and/or within the random access procedure). The UE transmits information related to a QoS requirement(s) of (upcoming) service(s) (e.g. in Msg3 and/or with the UL grant and/or within the random access procedure). The UE transmits information (e.g. in Msg3 and/or with the UL grant and/or within the random access procedure) for the base station to determine whether to turn on the serving cell. The UE transmits information (e.g. in Msg3 and/or with the UL grant and/or within the random access procedure) for the base station to determine whether to provide the first system information for the serving cell. The UE transmits information (e.g. in Msg3 and/or with the UL grant and/or within the random access procedure) for the base station to determine whether to broadcast the first system information for the serving cell.

The UE receives response to the request message (e.g.

RRCSetup/RRCResume/RRC Reject, e.g. in Msg4 and/or in a contention resolution). The response could comprise (all or part of) the first system information (e.g. in Msg4 and/or in a contention resolution). The response could comprise information included in or provided in the first system information (e.g. in Msg4 and/or in a contention resolution.

The UE transmits a complete message, e.g.

RRCSetupComplete/RRCResumeComplete, after the (single) random access procedure. The UE finishes RRC setup procedure/RRC resume procedure after the (single) random access procedure. The UE enters RRC connected state after the (single) random access procedure. The UE acquires the first system information via broadcasted message (e.g. scheduled by DCI scrambled with SI-RNTI). The UE acquires the first system information via broadcasted message after the (single) random access procedure. The UE acquires the first system information via dedicated RRC message (e.g. scheduled by DCI scrambled with C-RNTI/TC-RNTI). The UE acquires the first system information via dedicated RRC message during or after the (single) random access procedure. The UE acquires the first system information via RAR. The UE acquires the first system information via Msg4. The UE acquires the first system information during the (single) random access procedure. The UE acquires the first system information after the (single) random access procedure. The UE acquires the first system information and/or setup/resume RRC connection during the (single) random access procedure. The UE acquires the first system information and/or setup/resume RRC connection after the (single) random access procedure. The first system information could be SIB1. The first system information could be information carried by SIB1. The first system information could be MIB. The first system information could be MIB on/of/for another serving cell.

In another embodiment, a base station receives/detects a preamble (e.g. on a PRACH) from a UE. The preamble and/or the PRACH is for the UE to initiate the random access procedure to setup or resume a (RRC) connection. The preamble and/or the PRACH is for the UE to initiate the random access both to request the first system information and to setup or resume the (RRC) connection. The random access procedure is or could be a contention based random access procedure. The random access procedure is not allowed to be or could not be a non-contention based random access procedure. The preamble and/or the PRACH is selected by the UE (e.g. among several/all candidates). The preamble and/or PRACH could be indicative of the UE is requesting the first system information and/or set up/resume RRC connection.

The base station provides/transmits indication in MIB/SSB which is indicative of whether and/or how UE could request the first system information. The indication in MIB/SSB is for the UE to determine whether to initiate the random access procedure. The indication in MIB/SSB is for the UE to determine whether to access/select another cell. The indication in MIB/SSB is for the UE to determine whether to perform cell selection/reselection.

The base station transmits random access response in response to reception/detection of the (selected) preamble an/or the (selected) PRACH. The random access response could indicate acknowledge of reception of the request for the first system information. The random access response could indicate whether the request (for the first system information) is accepted or not (e.g. rejected). The random access response could comprise (all or part of) the first system information. The random access response could comprise information included in or provided in the first system information. The base station could provide the first system information for the serving cell if/when the request is accepted. The base station could broadcast the first system information for the serving cell if/when the request is accepted.

The UE could continue to access the serving cell if/when the request is accepted. The UE could access another serving cell if/when the request is not accepted or rejected. The UE could perform cell selection/re-selection if/when the request is not accepted or rejected. The random access response could indicate whether the first system information is (to be) provided (e.g. in the following) or not. The random access response could provide the first system information. The random access response could indicate an UL grant for Msg3.

The UL grant is used for UE to transmit its identity or identification. The UL grant is used for UE to transmit a message for requesting RRC connection setup or a message for requesting RRC connection resume (e.g. RRCSetupRequest/RRCResumeRequest/RRCResumeRequest1). The UL grant is used for UE to transmit information related to a cause/purpose of the request. The UL grant is used for UE to transmit information for the base station to determine whether to turn on the serving cell. The UL grant is used for UE to transmit information for the base station to determine whether to provide the first system information for the serving cell. The UL grant is used for UE to transmit information for the base station to determine whether to broadcast the first system information for the serving cell.

The base station receives a message from the UE for requesting RRC connection setup or a message for requesting RRC connection resume to the base station (e.g. in Msg3 and/or with the UL grant and/or within the random access procedure). The base station receives information related to a cause/purpose of the request (e.g. in Msg3 and/or with the UL grant and/or within the random access procedure). The base station receives information related to a QoS requirement(s) of (upcoming) service(s) (e.g. in Msg3 and/or with the UL grant and/or within the random access procedure). The base station receives information (e.g. in Msg3 and/or with the UL grant and/or within the random access procedure) for the base station to determine whether to turn on the serving cell. The base station receives information (e.g. in Msg3 and/or with the UL grant and/or within the random access procedure) for the base station to determine whether to provide the first system information for the serving cell. The base station receives information (e.g. in Msg3 and/or with the UL grant and/or within the random access procedure) for the base station to determine whether to broadcast the first system information for the serving cell.

The base station transmits response to the request message (e.g. RRCSetup/RRCResume/RRC Reject), e.g. in Msg4 and/or in a contention resolution. The response could comprise (all or part of) the first system information (e.g. in Msg4 and/or in a contention resolution). The response could comprise information included in or provided in the first system information (e.g. in Msg4 and/or in a contention resolution. The base station receives a complete message, e.g. RRCSetupComplete/RRCResumeComplete, after the (single) random access procedure.

The UE finishes RRC setup procedure/RRC resume procedure after the (single) random access procedure. The UE enters RRC connected state after the (single) random access procedure.

The base station provides the first system information via broadcasted message (e.g. scheduled by DCI scrambled with SI-RNTI). The base station provides the first system information via broadcasted message after the (single) random access procedure. The base station provides the first system information via dedicated RRC message (e.g. scheduled by DCI scrambled with C-RNTI/TC-RNTI). The base station provides the first system information via dedicated RRC message during or after the (single) random access procedure. The base station provides the first system information via RAR. The base station provides the first system information via Msg4. The base station provides the first system information during the (single) random access procedure. The base station provides the first system information after the (single) random access procedure. The base station provides the first system information and/or setup/resume RRC connection for the UE during the (single) random access procedure. The base station provides the first system information and/or setup/resume RRC connection for the UE after the (single) random access procedure. The first system information could be SIB1. The first system information could be information carried by SIB1. The first system information could be MIB. The first system information could be MIB on/of/for another serving cell.

In another embodiment, a UE initiates a random access procedure to request a first system information on a serving cell. An indication in MIB/SSB is indicative of whether and/or how UE could request the first system information. The UE determines whether to initiate the random access procedure based on the indication. The UE determines whether to access/select another cell based on the indication. The UE determines whether to perform cell selection/reselection based on the indication.

The UE receives random access response in response to transmission of a preamble and/or in a PRACH. The random access response could indicate acknowledge of reception of the request for the first system information. The random access response indicates how the first system information is provided. The random access response indicates the first system information is provided by which of one or more of the following: RAR, Msg4, broadcasted message/PDSCH, and/or dedicated RRC message. The random access response indicates how the first system information is provided. The random access response indicates the first system information is provided by which of some or all of the following: RAR, Msg4, broadcasted message/PDSCH, and/or dedicated RRC message. The random access response indicates the first system information is provided by RAR or broadcasted message/PDSCH.

The random access response could indicate whether the request (for the first system information) is accepted or not (e.g. rejected). The random access response could comprise (all or part of) the first system information. The random access response could comprise information included in or provided in the first system information. The random access response could indicate whether the first system information is (to be) provided (e.g. in the following) or not. The random access response could provide the first system information. The random access response could indicate an UL grant for Msg3. The random access response could not indicate an UL grant for Msg3. The random access procedure could be a contention based random access procedure. The random access procedure could be a non-contention based random access procedure.

The UE acquires the first information based on RAR. The UE acquires the first system information via broadcasted message (e.g. scheduled by DCI scrambled with SI-RNTI). The UE acquires the first system information via broadcasted message (e.g. scheduled by DCI scrambled with SI-RNTI) if/when RAR indicates the first information is provided via broadcasted message/PDSCH. The UE acquires the first system information via broadcasted message after the random access procedure. The UE acquires the first system information via dedicated RRC message (e.g. scheduled by DCI scrambled with C-RNTI/TC-RNTI). The UE acquires the first system information via dedicated RRC message (e.g. scheduled by DCI scrambled with C-RNTI/TC-RNTI) if/when RAR indicates the first information is provided via dedicated RRC message. The UE acquires the first system information via dedicated RRC message during or after the random access procedure. The UE acquires the first system information via RAR. The UE acquires the first system information via RAR if/when RAR indicates the first information is provided via RAR. The UE acquires the first system information via Msg4. The UE acquires the first system information via Msg4 if/when RAR indicates the first information is provided via Msg4. The UE acquires the first system information during the random access procedure. The UE acquires the first system information after the random access procedure. The first system information could be SIB1. The first system information could be information carried by SIB1. The first system information could be MIB. The first system information could be MIB on/of/for another serving cell.

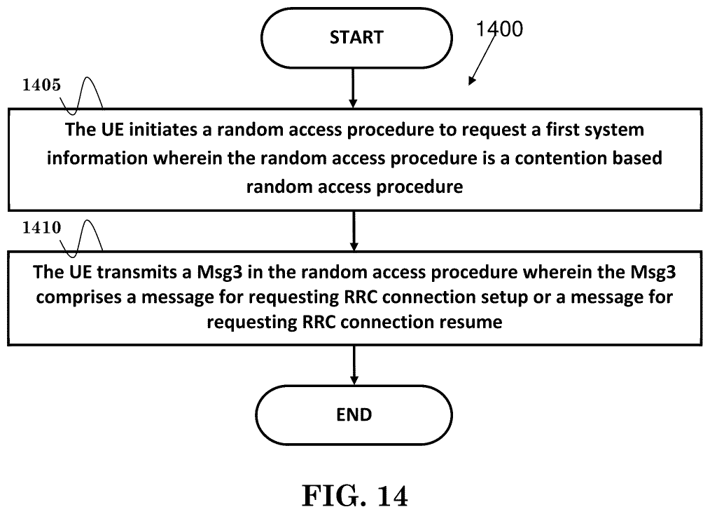

FIG. 14 is a flow chart 1400 for a User Equipment (UE). In step 1405, the UE initiates a random access procedure to request a first system information wherein the random access procedure is a contention based random access procedure. In step 1410, the UE transmits a Msg3 in the random access procedure wherein the Msg3 comprises a message for requesting RRC connection setup or a message for requesting RRC connection resume.

In one embodiment, the first system information could be SIB1. The UE could initiate the random access procedure to setup or resume the RRC connection. The UE could request the first system information and request to set up or resume the RRC connection within a single random access procedure. The UE could select a preamble and/or a PRACH for the random access procedure. The UE could select a preamble and/or a PRACH among preambles and/or PRACHs available for requesting the first system information and for RRC connection setup or resume.

In one embodiment, a RAR of the random access procedure could indicate or comprise an uplink grant for the message for requesting RRC connection setup or the message for requesting RRC connection resume. The RAR of the random access procedure could indicate whether and/or how the first system information is to be provided.

In one embodiment, the UE could receive RRCSetup/RRCResume/RRC Reject in Msg4 of the random access procedure. The UE could transmit a complete message after the random access procedure. The UE could acquire the first information during the random access procedure. The UE could acquire the first information in RAR or Msg4 of the random access procedure. The UE could acquire the first information in a broadcasted message. The UE could acquire the first information after the random access procedure. The UE could acquire the first information after setup or resume the RRC connection.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information wherein the random access procedure is a contention based random access procedure, and (ii) to transmit a Msg3 in the random access procedure wherein the Msg3 comprises a message for requesting RRC connection setup or a message for requesting RRC connection resume. Furthermore, the CPU 308 can execute the program code 312 to perform all of the above-described actions and steps or others described herein.

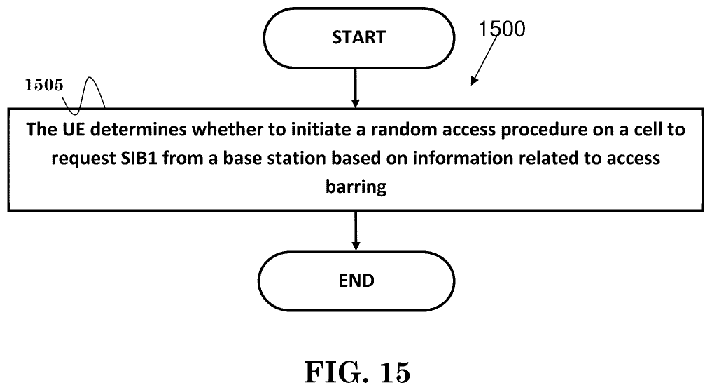

FIG. 15 is a flow chart 1500 for a User Equipment (UE). In step 1505, the UE determines whether to initiate a random access procedure on a cell to request SIB1 from a base station based on information related to access barring.

In one embodiment, the information related to access baring comprises a type of the UE. The type of the UE comprises whether the UE is a RedCap UE and/or whether the UE is a Non-terrestrial networks (NTN) UE. The information related to access barring may be provided by a base station.

In one embodiment, the UE could initiate the random access procedure to request SIB1 if a first value of the information related to access barring is provided. The first value of the information related to access barring indicates the UE may not be barred and/or may indicate the UE is allowed to access the cell. The UE could initiate the random access procedure to request SIB1 if the information related to access barring indicates the UE may not be barred and/or may indicate the UE is allowed to access the cell. The UE may not initiate the random access procedure to request SIB1 if a second value of the information related to access barring is provided. The second value of the information related to access barring indicates the UE may be barred and/or may indicate the UE is not allowed to access the cell. The UE may not initiate the random access procedure to request SIB1 if a second value of the information related to access barring indicates the UE may be barred and/or may indicate the UE is not allowed to access the cell.

In one embodiment, the UE could perform cell selection if the UE does not initiate the random access procedure to request SIB1. The information related to access barring comprises one or more of intraFreqReselectionRedCap and/or cellBarredNTN.

Referring back to FIGS. 3 and 4, in one exemplary embodiment from the perspective of a UE. The UE 300 includes a program code 312 stored in the memory 310. The CPU 308 could execute program code 312 to enable the UE to determine whether to initiate a random access procedure on a cell to request SIB1 from a base station based on information related to access barring. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
the UE determines whether to initiate a random access procedure on a cell to request SIB1 from a base station based on information related to access barring.

2. The method of claim 1, wherein the information related to access baring comprises a type of the UE.

3. The method of claim 2, wherein the type of the UE comprises whether the UE is a RedCap UE and/or whether the UE is a Non-terrestrial networks (NTN) UE.

4. The method of claim 1, wherein the information related to access barring is provided by a base station.

5. The method of claim 4, wherein the UE initiates the random access procedure to request SIB1 if a first value of the information related to access barring is provided.

6. The method of claim 4, wherein the UE initiates the random access procedure to request SIB1 if the information related to access barring indicates the UE is not barred and/or indicates the UE is allowed to access the cell.

7. The method of claim 4, wherein the UE does not initiate the random access procedure to request SIB1 if a second value of the information related to access barring is provided.

8. The method of claim 4, wherein the UE does not initiate the random access procedure to request SIB1 if the information related to access barring indicates the UE is barred and/or indicates the UE is not allowed to access the cell.

9. The method of claim 7, wherein the UE performs cell selection if the UE does not initiate the random access procedure to request SIB1.

10. The method of claim 1, wherein the information related to access barring comprises one or more of intraFreqReselectionRedCap and/or cellBarredNTN.

11. A User Equipment (UE), comprising:
a control circuit;
a processor installed in the control circuit; and
a memory installed in the control circuit and operatively coupled to the processor;
wherein the processor is configured to execute a program code stored in the memory to:
determine whether to initiate a random access procedure on a cell to request SIB1 from a base station based on information related to access barring.

12. The UE of claim 11, wherein the information related to access baring comprises a type of the UE.

13. The UE of claim 12, wherein the type of the UE comprises whether the UE is a RedCap UE and/or whether the UE is a Non-terrestrial networks (NTN) UE.

14. The UE of claim 12, wherein the information related to access barring is provided by a base station.

15. The UE of claim 14, wherein the processor is further configured to execute a program code stored in the memory to:
initiate the random access procedure to request SIB1 if a first value of the information related to access barring is provided.

16. The UE of claim 14, wherein the processor is further configured to execute a program code stored in the memory to:
initiate the random access procedure to request SIB1 if the information related to access barring indicates the UE is not barred and/or indicates the UE is allowed to access the cell.

17. The UE of claim 14, wherein the processor is further configured to execute a program code stored in the memory to:
not initiate the random access procedure to request SIB1 if a second value of the information related to access barring is provided.

18. The UE of claim 14, wherein the processor is further configured to execute a program code stored in the memory to:
not initiate the random access procedure to request SIB1 if the information related to access barring indicates the UE is barred and/or indicates the UE is not allowed to access the cell.

19. The UE of claim 17, wherein the processor is further configured to execute a program code stored in the memory to:
perform cell selection if the UE does not initiate the random access procedure to request SIB1.

20. The UE of claim 11, the information related to access barring comprises one or more of intraFreqReselectionRedCap and/or cellBarredNTN.
